(19) United States
(12) Patent Application Publication
(10) Pub. No.: US 2007/0152951 A1
(43) Pub. Date: Jul. 5, 2007

(54) Liquid crystal display device and driving method thereof

(75) Inventor: Ji Young Ahn, Gyeonggi-so (KR)

Correspondence Address: SEYFARTH SHAW, LLP, 815 CONNECTICUT AVENUE, N.W., SUITE 500, WASHINGTON, DC, 20006, US

(73) Assignee: LG.PHILIPS LCD CO., LTD., Seoul (KR)

(21) Appl. No.: 11/589,876

(22) Filed: Oct. 31, 2006

(30) Foreign Application Priority Data
Dec. 29, 2005 (KR) 10-2005-0132789
Aug. 25, 2006 (KR) 10-2006-080887

(51) Int. Cl. G09G 3/36

(52) U.S. Cl. 345/102

(57) ABSTRACT

A liquid crystal display device includes a liquid crystal panel having first data lines crossing gate lines on a first region of the liquid crystal panel and second data lines crossing the gate lines on a second region of the liquid crystal panel; a data converter for converting a first video data having a first frame frequency into a second video data having a second frame frequency, which is higher than the first frame frequency; a backlight unit having a first lamp group with at least two lamps for respectively irradiating light onto sub-regions of the first region and a second lamp group with at least two lamps respectively irradiating light on sub-regions of the second region; and a driver for driving the gate lines, the first data lines and the second data lines in accordance with the second video data and for driving the first and second lamp groups at the second frame frequency so that the lamps of the first lamp group are sequentially turned on and off in synchronization with the lamps of the second lamp group.

This application claims the benefit of the Korean Patent Application Nos. 10-2005-0132789, filed on Dec. 29, 2005, and 10-2006-080887, filed on Aug. 25, 2006, both of which are hereby incorporated by reference in their entirety.

### BACKGROUND OF THE INVENTION

1. Field of the Invention

Embodiments of the present invention relates to a display device, and more particularly, to a liquid crystal display device and a driving method thereof. Embodiments of the present invention are suitable for a wide scope of applications. In particular, some embodiments are suitable for preventing image-sticking and/or image blur.

2. Description of the Related Art

As the information society develops, demand for various flat panel display devices is increasing. To meet such a demand, flat panel display devices, such as liquid crystal display device (LCD), plasma display panel (PDP), and electroluminescent display (ELD), have been developed. In particular, LCDs are lightweight, slim and have low power consumption. Also, LCDs can provide high image quality. Because LCDs have these advantages, LCDs have been replacing CRTs. For example, LCDs are widely used as monitors for TVs, computer displays and other types of display devices.

LCDs display images using optical anisotropy and polarization characteristics of liquid crystal molecules to display an image. Since the liquid crystal molecule is thin and long, liquid crystal molecules can be aligned in a predetermined direction. The direction of the molecular alignment of the liquid crystal molecules can be controlled by applying an electric field across the liquid crystal molecule. When the direction of the molecular alignment of the liquid crystal is controlled, the liquid crystal can be arranged such that the polarization state of light is changed along a chain of the liquid crystal molecules. Thus, by controlling the direction of the molecular alignment of the liquid crystal molecules, image information can be displayed.

FIG. 1 is a schematic diagram of a related art LCD. As shown in FIG. 1, the related art LCD includes a liquid crystal panel 2 for displaying an image, a gate driver 4 and a data driver 6 for driving the liquid crystal panel 2, a timing controller 8 for controlling the gate driver 4 and the data driver 6, and a backlight unit 10 for generating light with a predetermined brightness that is irradiated onto the liquid crystal panel 2.

In the liquid crystal panel 2, a plurality of gate lines GL1 to GLn and a plurality of data lines DL1 to DLm are arranged to cross each other. Thin film transistors (TFTs) serve as switching elements at the crossings of the gate lines GL1 to GLn and the data lines DL1 to DLm. The TFTs are responsive to scan signals applied on corresponding gate lines GL to switch data voltages supplied from corresponding data lines DL to liquid crystal cells Clc, which are connected to a common voltage line Vcom.

The gate driver 4 supplies the scan signals to the gate lines GL1 to GLn in response to gate control signals generated from the timing controller 8. The scan signals are supplied to the gate lines GL1 to GLn and each of the scan signals has a pulse of gate high voltage VGH, which is sequentially shifted. The pulse of the high voltage VGH has a width equal to a period of a horizontal sync signal. In response to the scan signals, the gate lines GL1 to GLn are sequentially enabled once in each frame period, that is, in each period of a vertical sync signal.

The data driver 6 is responsive to data control signals to convert red (R), green (G) and blue (B) pixel data for one line into analog data voltages. The data driver 6 periodically supplies the one-line data voltages to the data lines DL1 to DLm in accordance with a period of a horizontal sync signal.

The timing controller 8 generates the gate control signals, the data control signals, and the backlight control signals using vertical/horizontal sync signals (Vsync/Hsync), data enable signal (DE), and clock signal, which are generated from an external system (not shown), such as graphic card of computer system or TV signal decoder module of television receiver. In addition, the timing controller 8 receives video data containing R, G and B pixel data for each pixel, that is, in each frame, from a system (not shown), and supplies the inputted pixel data to the data driver 6 in line by line fashion.

The backlight unit 10 includes lamps (not shown), optical sheets, and a lamp driver for driving the lamps. The lamps generate light with a predetermined brightness in response to a lamp driving signal supplied from the lamp driver and provide the generated light to the liquid crystal panel 2. The lamp driver generates the lamp driving voltage for driving the lamps by using a power voltage (Vdd) supplied from a power supply (not shown). The lamp driving voltage is supplied to the lamps according to the lamp control signal generated by the timing controller 8.

The timing controller 8 generates the gate control signal, the data control signal, and the backlight control signal. When the gate control signal is supplied to the gate driver 4, the gate driver 4 supplies the scan signals having the sequentially shifted pulses of gate high voltage VGH to the gate lines GL1 to GLn. The gate lines GL1 to GLn are sequentially enabled by the gate high voltage VGH of the scan signals. A TFT connected to the enabled gate line GL is turned on, so that the data voltage on the data line DL corresponding to the TFT is transferred to the corresponding liquid crystal cell Clc. Thereafter, when the scan signal changes from the gate high voltage VGH to a gate low voltage VGL, the TFT is turned off, so that the data line DL is electrically disconnected from the corresponding liquid crystal cell Clc. The liquid crystal cell Clc maintains the data voltage charged during the period of the pulse until another pulse of gate high voltage VGH is supplied in a next frame. The liquid crystal panel 2 is driven through this procedure such that an image is displayed on the liquid crystal panel 2.

While the data voltage supplied to the liquid crystal cell is maintained during one frame, the lamps of the backlight unit 10 are on, regardless of timing in a frame. When displaying a moving picture, such a hold-type LCD cannot cope with the rapid image changes and a motion blurring phenomenon occurs. Consequently, an unclear image or image-sticking occurs in the LCD, which degrades image quality.

In addition, in the related art LCD, a predetermined time (hereinafter, referred to as an alignment saturation period) is required for alignment of the liquid crystal molecules of the liquid crystal cells in a direction corresponding to an applied data voltage after the data voltage has been applied to the liquid crystal cells. During the alignment saturation period, the liquid crystal cells cannot correctly display the pixel data, thereby causing a motion blurring phenomenon and a more serious degradation of the image quality.

### SUMMARY OF THE INVENTION

Accordingly, embodiments of the present invention are directed to an LCD and a driving method thereof that substantially obviate one or more problems due to limitations and disadvantages of the related art.

An object of embodiments of the present invention is to provide an LCD that can improve the image quality by preventing motion blur.

Another object of embodiments of the present invention is to provide a method of driving an LCD that can improve the image quality by preventing motion blur.

Another object of embodiments of the present invention is to provide an LCD that can improve the image quality by preventing image-sticking.

Another object of embodiments of the present invention is to provide a method of driving an LCD that can improve the image quality by preventing image-sticking.

Additional advantages, objects, and features of embodiments of the present invention will be set forth in part in the description which follows and in part will become apparent to those having ordinary skill in the art upon examination of the following or may be learned from practice of embodiments of the present invention. The objectives and other advantages of embodiments of the present invention may be realized and attained by the structure particularly pointed out in the written description and claims hereof as well as the appended drawings.

To achieve these objects and other advantages and in accordance with the purpose of embodiments of the present invention, as embodied and broadly described herein, a liquid crystal display device includes a liquid crystal panel having first data lines crossing gate lines on a first region of the liquid crystal panel and second data lines crossing the gate lines on a second region of the liquid crystal panel; a data converter for converting a first video data having a first frame frequency into a second video data having a second frame frequency, which is higher than the first frame frequency; a backlight unit having a first lamp group with at least two lamps for respectively irradiating light onto sub-regions of the first region and a second lamp group with at least two lamps respectively irradiating light on sub-regions of the second region; and a driver for driving the gate lines, the first data lines and the second data lines in accordance with the second video data and for driving the first and second lamp groups at the second frame frequency so that the lamps of the first lamp group are sequentially turned on and off in synchronization with the lamps of the second lamp group.

In another aspect, a liquid crystal display device includes a liquid crystal panel having gate lines and data lines crossing each other; a backlight unit having a first lamp group with at least two lamps for divisionally irradiating light on a first region of the liquid crystal panel and a second lamp group with at least two lamps divisionally irradiating light on a second region of the liquid crystal panel; and a driver for driving the gate lines and data lines in accordance with a video data having first frame frequency and for controlling the first and second lamp groups to be simultaneously driven at a second frame frequency higher than the first frame frequency so that the lamps of the first lamp group are sequentially turned on and off in synchronization with the lamps of the second lamp group.

In another aspect, a liquid crystal display device includes a liquid crystal panel having first data lines crossing gate lines on a first region of the liquid crystal panel and second data lines crossing the gate lines on a second region of the liquid crystal panel; a backlight unit having a first lamp group with at least two lamp for respectively irradiating light onto sub-regions of the first region and a second lamp group with at least two lamps respectively irradiating light on sub-regions of the second region; and a driver for driving the gate lines and the data lines to simultaneously write data voltages of a video data to liquid crystal cells of the first region and liquid crystal cells of the second region in each frame in line by line fashion, and for driving the first and second lamp groups so that the at least two lamps of the first lamp group are sequentially turned on and off once in synchronization with the at least two lamps of the second lamp group.

In another aspect, a liquid crystal display device includes a liquid crystal panel having first data lines crossing gate lines on a first region of the liquid crystal panel and second data lines crossing the gate lines on a second region of the liquid crystal panel; a backlight unit having a first lamp group with at least two lamps for respectively irradiating light onto sub-regions of the first region and a second lamp group with at least two lamps respectively irradiating light on sub-regions of the second region; and a driver for operating the gate lines and the data lines to simultaneously write data voltages of a video data to liquid crystal cells of the first region and liquid crystal cells of the second region in each frame in a line by line manner, and for driving the first and second lamp groups so that the lamps of the first and second lamp groups are turned on and off at time when an alignment saturation period elapses after the data voltages are written to liquid crystal cells of the corresponding sub-regions.

In another aspect, a liquid crystal display device includes a liquid crystal panel having gate lines and data lines crossing each other; a backlight unit having a first lamp group with at least two lamps for divisionally irradiating light on a first region of the liquid crystal panel and a second lamp group with at least two lamps for divisionally irradiating light on a second region of the liquid crystal panel; and a driver for driving the gate lines and data lines to sequentially write data voltages of a video data to liquid crystal cells of the liquid crystal panel in each frame in line by line manner, and for controlling the first and second lamp groups to be sequentially turned on and off once in synchronization with each other.

In another aspect, a method is provided for driving a liquid crystal display device with a liquid crystal panel having first data lines crossing gate lines on a first region of the liquid crystal panel, and second data lines crossing the gate lines on a second region of the liquid crystal panel, the method including converting a first video data having a first frame frequency into a second video data having a second frame frequency higher than the first frame frequency; driving the gate lines, the first and second data lines in accordance with the second video data; and controlling the first and second lamp groups to turn-on and turn-off simultaneously at the second frame frequency, the first lamp groups having at least two lamps for a first region and the second lamp group having at least two lamps for the second region.

In another aspect, a method is provided for driving a liquid crystal display device with a liquid crystal panel having gate lines and data lines crossing each other, the method including driving the gate lines and data lines in accordance with a video data having a first frame frequency; and controlling the first and second lamp groups to turn-on and turn-off simultaneously at a second frame frequency higher than the first frame frequency, the first lamp group having at least two lamps for a first region of the liquid crystal panel and the second lamp group having at least two lamps for a second region of the liquid crystal panel.

In another aspect, a method is provided for controlling a liquid crystal display device having a liquid crystal panel with first data lines crossing gate lines on a first region and second data lines crossing the gate lines on a second region, at least two first lamps partially corresponding to the first region of the liquid crystal panel, and at least two second lamps partially corresponding to the second region of the liquid crystal panel, the method including driving the gate lines and data lines to simultaneously write data voltages of a video data to liquid crystal cells of the first region and liquid crystal cells of the second region in line by line fashion; and turning on and off once the first lamps together with the second lamps by one pair at a time.

In another aspect, a method is provided for controlling a liquid crystal display device having a liquid crystal panel with first data lines crossing gate lines on a first region and second data lines crossing the gate lines on a second region, at least two first lamps partially corresponding to the first region of the liquid crystal panel, and at least two second lamps partially corresponding to the second region of the liquid crystal panel, the method including driving the gate lines and data lines to simultaneously write data voltages of a video data to liquid crystal cells of the first region and liquid crystal cells of the second region in a line by line manner; and driving the first and second lamps so that the lamps of the first and second lamps are turned on and off at time when an alignment saturation period elapses after the data voltages are written to liquid crystal cells on the liquid crystal panel.

It is to be understood that both the foregoing general description and the following detailed description of embodiments of the present invention are exemplary and explanatory and are intended to provide further explanation of embodiments of the present invention as claimed.

### BRIEF DESCRIPTION OF THE DRAWINGS

The accompanying drawings, which are included to provide a further understanding of embodiments of the present invention and are incorporated in and constitute a part of this application, illustrate embodiments of the present invention and together with the description serve to explain the principle of embodiments of the present invention. In the drawings:

FIG. 1 is a schematic diagram of a related art LCD;

FIG. 2 is a schematic diagram of an LCD according to a first embodiment of the present invention;

FIG. 3 is a timing diagram of the respective parts of FIG. 2;

FIG. 4 is a schematic diagram of an LCD according to a second embodiment of the present invention;

FIG. 5 is a timing diagram of the respective parts of FIG. 4;

FIG. 6 is a schematic diagram of an LOG type LCD according to a third embodiment of the present invention;

FIG. 7 is a schematic diagram of an LCD according to a fourth embodiment of the present invention;

FIG. 8 is a schematic diagram of an LCD according to a fifth embodiment of the present invention;

FIGS. 9A and 9B are timing diagrams of respective parts of FIG. 8 according to a first driving mode; and

FIGS. 10 and 10B are timing diagrams of respective parts of FIG. 8 according to a second driving mode.

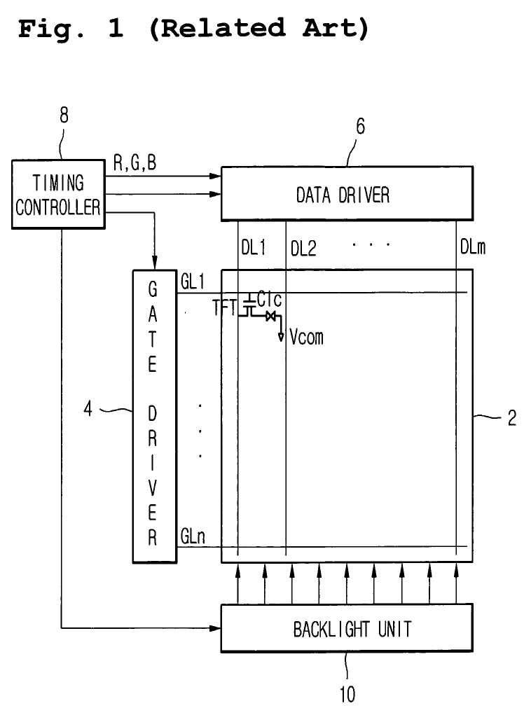

### DETAILED DESCRIPTION OF EMBODIMENTS

Reference will now be made in detail to embodiments of the present invention, examples of which are illustrated in the accompanying drawings. Wherever possible, the same reference numbers will be used throughout the drawings to refer to the same or like parts.

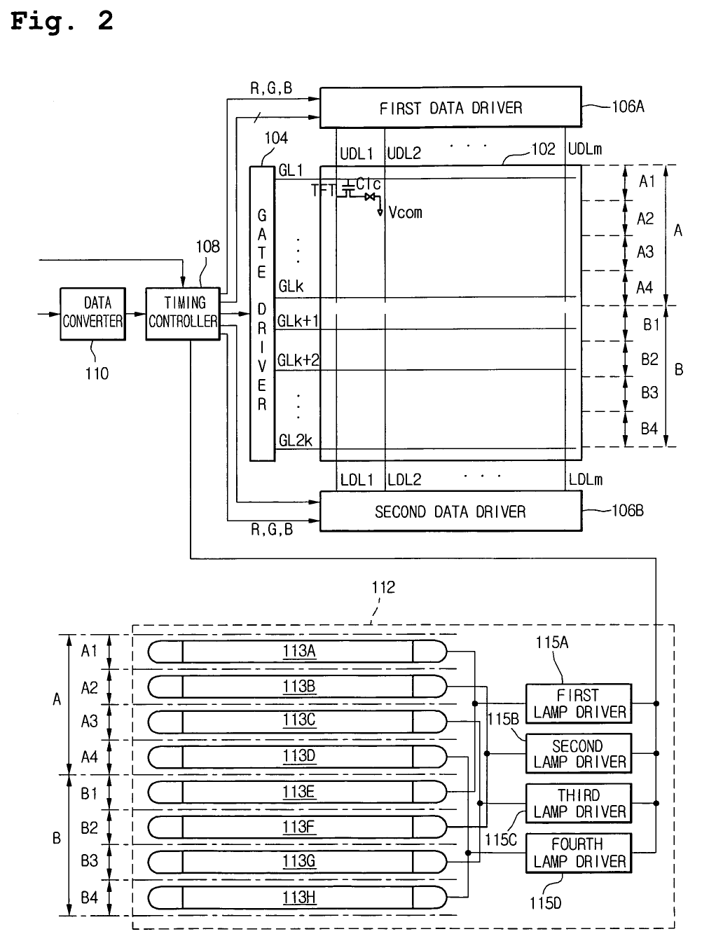

FIG. 2 is a schematic diagram of an LCD according to a first embodiment of the present invention. As shown in FIG. 2, the LCD includes a liquid crystal panel 102 for displaying an image, a gate driver 104 for driving a plurality of gate lines GL1-GL2k on the liquid crystal panel 102, a first data driver 106A for driving a plurality of upper data lines UDL1-UDLm formed on the liquid crystal panel 102, and a second data driver 106B for driving a plurality of lower data lines LDL1-LDLm on the liquid crystal panel 102.

The upper data lines UDL1-UDLm are arranged on an upper portion A of the liquid crystal panel 102 and cross a first k number of gate lines GL1-GLk arranged in a vertical direction. The lower data lines LDL1-LDLm are arranged on a lower portion B of the liquid crystal panel 102 and cross a second k number of gate lines GL(k+1)-GL2k arranged in a vertical direction. TFTs, acting as switching elements, are formed at crossings of the gate lines GL1-GL2k and the upper and lower data lines UDL1-UDLm and LDL1-LDLm. In response to scan signals applied on the corresponding gate lines GL, the TFTs switch data voltages supplied from the corresponding data lines UDL and LDL to liquid crystal cells Clc connected to common voltage lines Vcom. The liquid crystal cells Clc of the liquid crystal panel 102 transmit light proportionally or inversely proportional to an electric potential difference between the data voltages of the data lines UDL and LDL and the reference voltage, that is, the common voltage Vcom.

The gate driver 104 generates the scan signals for the gate lines GL1-GL2k in response to the gate control signals. The scan signals from the gate driver 104 enable the first k number of gate lines GL1 to GLk to be sequentially driven once for a half period of one vertical sync signal, and enable the second k number of the gate lines GL(k+1)-GL2k sequentially once for a half period of one vertical sync signal. For example, while the first gate line GL1 on the upper portion A of the liquid crystal panel 102 is enabled (that is, for a period of one horizontal sync signal), the first gate line GL(k+1) on the lower portion B of the liquid crystal panel 102 also is enabled. In another example, for the period of one horizontal sync signal that the last gate line GLk at the upper portion A of the liquid crystal panel 102 is enabled, the last gate line GK2k on the lower portion B of the liquid crystal panel 102 also is enabled. Thus, each of the k number of scan signals supplied to the first k number of gate lines GL1-GLk arranged on the upper portion A of the liquid crystal panel 102 has shifted pulses of gate high voltage VGH. Likewise, each of the second k number of scan signals supplied to the second k number of gate lines GL(k+1)-GL2k arranged on the lower portion B of the liquid crystal panel 102 has a shifted pulse of gate high voltage VGH. The scan signals supplied to the first k number of gate lines GL1-GLk arranged on the upper portion A of the liquid crystal panel 102 have the same waveforms as the scan signals supplied to the second k number of gate lines GL(k+1)-GL2k arranged on the lower portion B of the liquid crystal panel 102. The pulse of the gate high voltage VGH contained in the scan signal has a width equal to the period of one horizontal sync signal.

The first data driver 106A converts R, G and B pixel data corresponding to one line into analog data voltages in response to the data control signals at each period of the horizontal sync signal, and supplies the one-line data voltages to the upper data lines UDL1-UDLm arranged on the upper portion A of the liquid crystal panel 102. In other words, the first data driver 106A outputs the one-line data voltages whenever any one of the gate lines GL1-GLk arranged on the upper portion A of the liquid crystal panel 102 is enabled, that is, in every period of one horizontal sync signal. When the pulse of the gate high voltage VGH enables one of the gate lines GL1-GLk, the TFT connected to the enabled gate line is turned on, so that the data voltage from the corresponding upper data line UDL is transferred to the corresponding liquid crystal cell Clc. When the scan signal changes from the gate high voltage VGH to the gate low voltage VGL, the turned-on TFT is turned off, so that the corresponding liquid crystal cell Clc is electrically disconnected from the corresponding upper data line UDL. The liquid crystal cell Clc is charged with the data voltage supplied from the corresponding data line UDL during the turn-on period of the TFT, and the charged data voltage is maintained until the corresponding TFT is turned on again.

Likewise, the second data driver 106B converts R, G and B pixel data corresponding to one line into analog data voltages in response to the data control signals at each period of the horizontal sync signal, and supplies the one-line data voltages to the lower data lines LDL1-LDLm arranged on the lower portion B of the liquid crystal panel 102. The second data driver 106B outputs the one-line data voltages whenever any one of the gate lines GL(k+1)-GL2k arranged on the lower portion B of the liquid crystal panel 102 is enabled, that is, in every period of one horizontal sync signal. When the pulse of the gate high voltage VGH enables one of the gate lines GL(k+1)-GL2k, the TFT connected to the enabled gate line is turned on, so that the data voltage from the corresponding lower data line LDL is transferred to the corresponding liquid crystal cell Clc. When the scan signal changes from the gate high voltage VGH to the gate low voltage VGL, the turned-on TFT is turned off, so that the corresponding liquid crystal cell Clc is electrically disconnected from the corresponding lower data line LDL. The liquid crystal cell Clc is charged with the data voltage supplied from the corresponding data line LDL during the turn-on period of the TFT, and the charged data voltage is maintained until the corresponding TFT is turned on again.

The gate driver 104 and the first and second data drivers 106A and 106B write the data voltage to the liquid crystal cells of the liquid crystal panel 102 once for a half period of the frame period, that is, a half period of the vertical sync signal.

Referring to FIG. 2, the LCD includes a timing controller 108 for controlling the gate driver 104 and the first and second data drivers 106A and 106B, a data converter 110 for converting the frame frequency of the video data to be supplied to the timing controller 108, and a backlight unit 112 for irradiating light onto the liquid crystal panel 102. The timing controller 108 generates the gate control signals and the data control signals using vertical/horizontal sync signals (Vsync/Hsync), data enable signal (DE), and clock signal, which are generated from an external system (not shown), such as graphic card of computer system or TV signal decoder module of television receiver. In response to the gate control signals, the gate driver 104 enables the first k number of gate lines GL1-GLk arranged on the upper portion A of the liquid crystal panel 102 to be sequentially driven once for a half period of one vertical sync signal and forces the second k number of the gate lines GL(k+1)-GL2k arranged on the lower portion B of the liquid crystal panel 102 to be sequentially driven in synchronization with the first k number of the gate lines GL(k+1)-GL2k. In response to the data control signals, the first data driver 106A supplies the one-line data voltages to the upper data lines UDL1-UDLm whenever any one of the first k number of the gate lines GL1-GLk is enabled, the second data driver 106B also supplies the one-line data voltages to the lower data lines LDL1-LDLm whenever any one of the second k number of the gate lines GL(k+1)-GL2k is enabled.

In addition, the timing controller 108 arranges the R, G and B pixel data supplied from the external system into a line by line R, G and B pixel data, and supplies the one-line R, G and B pixel data to the first and second data drivers 106A and 106B. Therefore, the first and second data drivers 106A and 106B convert the l-line R, G and B pixel data into analog data voltages. The 1-line data voltages converted by the first data driver 106A and the 1-line data voltages converted by the second data driver 106B are simultaneously supplied to the upper and lower data lines UDL1-UDLm and LDL1-LDLm.

The data converter 110 converts the frame frequency of the frame-based pixel data supplied from the external system to the timing controller 108. The frame-based pixel data supplied from the external system to the data converter 110 has a frame frequency of a first integer (e.g., 60 Hz), the frame-based pixel data outputted from the data converter 110 has a frame frequency of a second integer (e.g., 120 Hz) corresponding to multiple of the first integer. In other words, the data converter 110 multiplies the frame frequency of the pixel data from the external system by at least two. The data converter 110 generates frame-based interpolation pixel data from the frame-based pixel data outputted from the external system, arranges the frame-based interpolation pixel data between the frame-based original pixel data to create new pixel data, and supplies the new pixel data to the timing controller 108. The timing controller 108 controls the gate driver 104 and the first and second data drivers 106A and 106B to drive the liquid crystal panel 102 at a frame frequency (e.g., 120 Hz) that is at least twice the original frame frequency (e.g., 60 Hz).

The backlight unit 112 includes first to eighth lamps 113A to 113H arranged in parallel under the liquid crystal panel 102. The first to fourth lamps 113A to 113D are arranged to correspond to the upper portion A of the liquid crystal panel 102, while the fifth to eighth lamps 113E to 113H are arranged to correspond to the lower portion B of the liquid crystal panel 102. The first to fourth lamps 113A to 113D irradiate light onto first to fourth sub-sections A1 to A4 defined by dividing the upper portion A of the liquid crystal panel 102 by four. For example, the first lamp 113A irradiates light to the uppermost sub-section A1 on the upper portion A of the liquid crystal panel 102, and the fourth lamp 113D irradiates light onto the lowermost sub-section A4 on the lower portion A of the liquid crystal panel 102. Likewise, the fifth to eighth lamps 113E to 113H irradiate light onto four sub-sections B1 to B4 defined by dividing the lower portion B of the liquid crystal panel 102 by four. For example, the fifth lamp 113E irradiates light onto the uppermost sub-section B1 on the lower portion B of the liquid crystal panel 102, and the eighth lamp 113H irradiates light onto the lowermost sub-section B4 on the lower portion B of the liquid crystal panel 102.

The backlight unit 112 includes first to fourth lamp drivers 115A to 115D commonly connected to the timing controller 108. Each of the first to fourth lamp drivers 115A to 115D simultaneously turns on and off (or turns off and on) one of the lamps for the upper portion A of the liquid crystal panel 102 and one of the lamps for the lower portion B of the liquid crystal panel 102. In response to the lamp control signals outputted from the timing controller 108, the first to fourth lamp drivers 115A to 115D sequentially turn on and off once the first to fourth lamps 113A to 113D for the upper portion A of the liquid crystal panel 102 for a half period of one vertical sync signal in such a way that the turn-on periods are shifted by a predetermined interval. The shift period between the tune-on periods of the first to fourth lamps 113A to 113D may be at least period in which the liquid crystal cells Clc on the sub-sections A1 to A4 of the liquid crystal panel 102 corresponding to the lamps 113A to 113D charge data voltages. Simultaneously, the first to fourth lamp drivers 115A to 115D turn on and off (in detail, after or before) once the fifth to eighth lamps 113E to 113H for the lower portion B of the liquid crystal panel 102 together with the first to fourth lamps 113A to 113D for the upper portion A of the liquid crystal panel 102. Therefore, the fifth to eighth lamps 113E to 113H are also sequentially turned on such that the turn-on periods are shifted at predetermined interval. In other words, the turn-on periods of the lamps 113A-113D or 113E-113G for the sub-sections A1-A4 or B1-B4 of the liquid crystal panel 102 can be different. Thus, at least one of lamp driving voltages generated by the first to fourth lamp drivers 115A to 115D have a different duty cycle from the others.

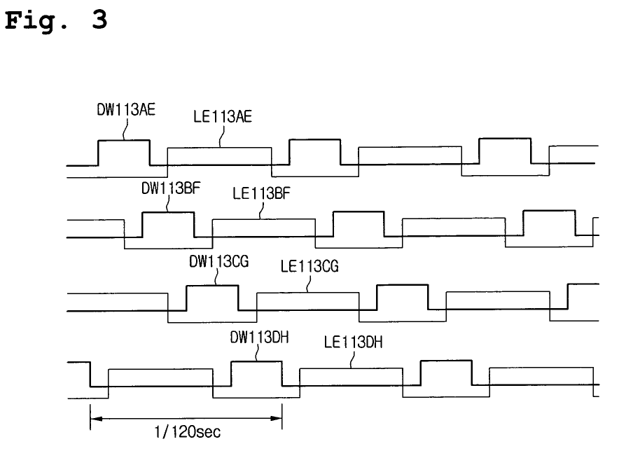

In response to the lamp control signal outputted from the timing controller 108, the first lamp driver 115A turns off and on the first lamp 113A for the uppermost sub-section A1 of the upper portion A of the liquid crystal panel 102 and the fifth lamp 113E for the uppermost sub-section B1 of the lower portion B of the liquid crystal panel 102 simultaneously once for a half frame period, or a half period of the vertical sync signal. The first lamp driver 115A turns off the first and fifth lamps 113A and 113E during the periods (high-voltage periods in DW113AE of FIG. 3) in which the data voltages are charging the liquid crystal cells Clc on the uppermost sub-sections A1 and B1 of the upper and lower portions A and B of the liquid crystal panel 102, or during the periods (low-voltage periods in LE113AE of FIG. 3) including predetermined intervals before and after the high-voltage periods. On the other hand, during the periods (low-voltage periods in DW113AE of FIG. 3) when the liquid crystal cell Clc on the uppermost sub-sections A1 and B1 of the liquid crystal panel 102 are maintaining the charged data voltages, the first lamp driver 115A turns on the first and fifth lamps 113A and 113E for a predetermined time (high-voltage period in LE113AE of FIG. 3).

In response to the lamp control signal outputted from the timing controller 108, the second lamp driver 115B turns off and on the second lamp 113B for the second uppermost sub-section A2 of the upper portion A of the liquid crystal panel 102 and the sixth lamp 113F for the second uppermost sub-section B2 of the lower portion B of the liquid crystal panel 102 simultaneously once for a half frame period, or a half period of the vertical sync signal. The second lamp driver 115B turns off the second and sixth lamps 113B and 113F during the periods (high-voltage periods in DW113BF of FIG. 3) when the data voltages are charging liquid crystal cells Clc in the second uppermost sub-sections A2 and B2 of the upper and lower portions A and B of the liquid crystal panel 102, or during the periods (low-voltage periods in LE113BF of FIG. 3) including predetermined intervals before and after the data voltage charging periods. On the other hand, during the periods in which the liquid crystal cell Clc on the second uppermost sub-sections A2 and B2 of the upper and lower portions A and B of the liquid crystal panel 102 are maintaining the charged data voltages, the second lamp driver 115B turns on the second and sixth lamps 113B and 113F during the period (high-voltage period in LE113BF of FIG. 3).

In response to the lamp control signal outputted from the timing controller 108, the third lamp driver 115C turns off and on the third lamp 113C for the second lowermost sub-section A3 of the upper portion A of the liquid crystal panel 102 and the seventh lamp 113G for the second lowermost sub-section B3 of the lower portion B of the liquid crystal panel 102 simultaneously once for a half frame period, or a half period of the vertical sync signal. The third lamp driver 115C turns off the third and seventh lamps 113C and 113G during the periods (high-voltage periods in DW113CG of FIG. 3) in which the data voltages are charging the liquid crystal cells Clc in the second lowermost sub-sections A3 and B3 on the upper and lower portions A and B of the liquid crystal panel 102, or during the periods (low-voltage periods in LE113CG of FIG. 3) including predetermined intervals before and after the data voltage charging periods. On the other hand, during the periods in which the liquid crystal cell Clc on the second lowermost sub-sections A3 and B3 of the liquid crystal panel 102 are maintaining the charged data voltages, the third lamp driver 115C turns on the third and seventh lamps 113C and 113G for a predetermined time (high-voltage period in LE113CG of FIG. 3).

In response to the lamp control signal outputted from the timing controller 108, the fourth lamp driver 115D turns off and on the fourth lamp 113D for the lowermost sub-section A4 of the upper portion A of the liquid crystal panel 102 and the eighth lamp 113H for the lowermost sub-section B4 of the lower portion B of the liquid crystal panel 102 simultaneously once for a half frame period, or a half period of the vertical sync signal. The fourth lamp driver 115D turns off the fourth and eighth lamps 113D and 113H during the periods (high-voltage periods in DW113DH of FIG. 3) in which the data voltages are charging the liquid crystal cells Clc in the lowermost sub-sections A4 and B4 of the upper and lower portions A and B of the liquid crystal panel 102, or during the periods (low-voltage periods in LE113DH of FIG. 3) including predetermined intervals before and after the data voltage charging periods. On the other hand, during the periods (low-voltage periods in DW113DH of FIG. 3) in which the liquid crystal cells Clc of the lowermost sub-sections A4 and B4 of the liquid crystal panel 102 are maintaining the charged data voltages, the fourth lamp driver 115D turns on the fourth and eighth lamps 113D and 113H for a predetermined time (high-voltage period in LE113DH of FIG. 3).

As can be seen from the timing diagram of FIG. 3, the first to fourth lamp drivers 115A to 115D are controlled by the timing controller 108 to sequentially turn on and off the first to fourth lamps 113A to 113D for the upper portion A of the liquid crystal panel 102 together with the fifth to eighth lamps 113E to 113H for the lower portion B of the liquid crystal panel 102 to be synchronized at every converted frame period while the data voltages are simultaneously written to the liquid crystal cells Clc in both the upper portion A of the liquid crystal panel 102 and the lower portion B of the liquid crystal panel 102. In other words, video data and black level data are alternately displayed once on the liquid crystal panel 102 at each frame having frame frequency (the second frame frequency of e.g., 120 Hz) that is twice the frame frequency (e.g., the first frame frequency of 60 Hz) of the video data generated from the external system. Therefore, the LCD according to embodiments of the present invention can display video data quickly on the liquid crystal panel. Thus, the motion blurring phenomenon does not occur when a moving picture is displayed. Further, providing charging data voltages simultaneously to two portions of the liquid crystal panel also prevents an unclear image or image-sticking so that the image is presented quickly. Thus, according to embodiments of the present invention, the LCD can display higher quality images.

Further, since the lamps for the sub-sections of the upper portion of the liquid crystal panel and the lamps for the sub-sections of the lower portion of the liquid crystal panel can be turned on and off by a single lamp driver, the circuit for driving the lamps can be simplified.

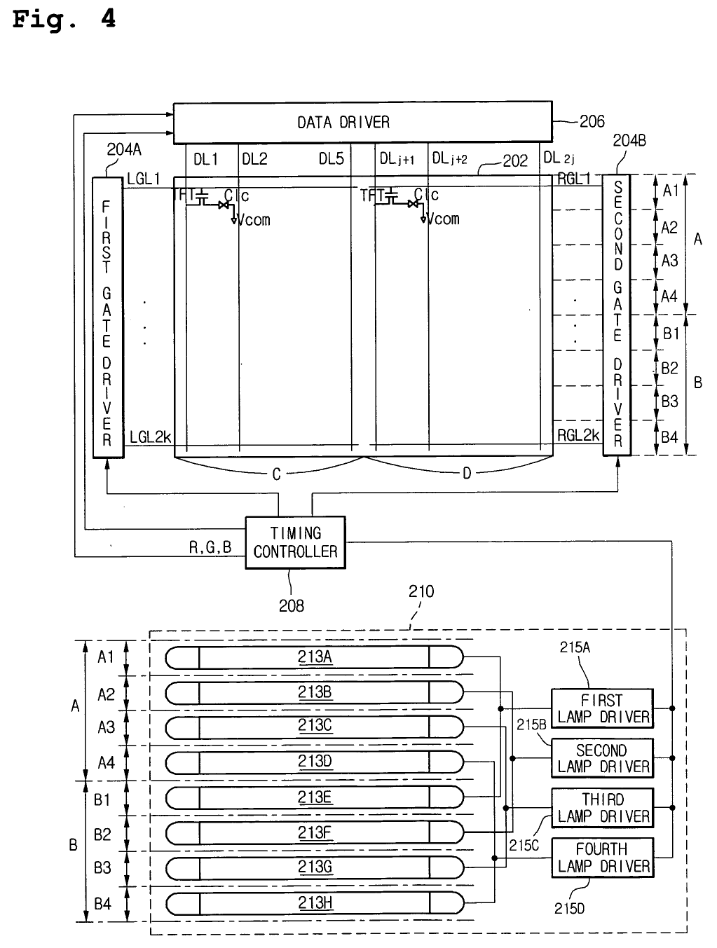

FIG. 4 is a schematic diagram of an LCD according to a second embodiment of the present invention. Referring to FIG. 4, the LCD includes a first gate driver 204A for driving a plurality of left gate lines LGL1-LGL2k disposed on the left of the liquid crystal panel 202, a second gate driver 204B for driving a plurality of right gate lines RGL1-RGL2k disposed on the right of the liquid crystal panel 202, and a data driver 206 for driving a plurality of data lines DL1-DL2j disposed on the liquid crystal panel 202.

The left gate lines LGL1-LGL2k are arranged on a left portion C of the liquid crystal panel 202 and cross a first j number of data lines DL1 to DLj arranged in a horizontal direction. The right gate lines RGL1-RGL2k are arranged on a right portion D of the liquid crystal panel 202 and cross a second j number of data lines DL(j+1)-DL2j arranged in a horizontal direction. TFTs acting as switching elements are formed at crossings between the data lines DL1-DL2j and the left and right gate lines LGL1-LGL2k and RGL2k-RGL2k. The TFTs are responsive to scan signals applied on corresponding gate lines GL to switch data voltages supplied from the corresponding data lines DL to liquid crystal cells Clc, which are connected to a common voltage line Vcom. The liquid crystal cells Clc of the liquid crystal panel 202 transmit light proportionally or inversely proportional to an electric potential difference between the data voltages of the data lines DL and the reference voltage, that is, the common voltage Vcom.

The first gate driver 204A generates the scan signals for the left gate lines LGL1-LGL2k in response to the gate control signals in each period of one vertical sync signal, that is, in each frame period. The scan signals from the first gate driver 204A enable the first 2k number of left gate lines LGL1 to LGL2k sequentially once for period of one vertical sync signal. The first 2k number of scan signals is supplied exclusively to the first 2k number of left gate lines LGL1-LGL2k arranged on the left portion C of the liquid crystal panel 202 as shifted pulses of gate high voltages VGH. The pulse of the gate high voltage VGH contained in the scan signal has a width equal to the period of one horizontal sync signal.

The second gate driver 204B generates the scan signals for the right gate lines RGL1-RGL2k in response to the gate control signals in each period of one vertical sync signal, that is, in each frame period. The scan signals from the second gate driver 204B enable the second 2k number of right gate lines RGL1 to RGL2k sequentially once for period of one vertical sync signal. The 2k number of scan signals generated from the second gate driver 204B has the same waveform as the 2k number of scan signals generated from the first gate driver 204A. Therefore, the right gate lines RGL1-RGL2k disposed on the right portion D of the liquid crystal panel 202 are simultaneously enabled or disabled together with the left gate lines LGL disposed at the left portion of the liquid crystal panel 202.

The data driver 206 converts R, G and B pixel data corresponding to one line into analog data voltages in response to the data control signals in each period of the horizontal sync signal, and supplies the one-line data voltages to the data lines DL1-DL2j arranged on the liquid crystal panel 202. The data driver 206 outputs the one-line data voltages when the 2k pairs of left and right gate lines LGL1-LGL2k and RGL1-RGL2k are sequentially enabled as pairs, that is, in each period of one horizontal sync signal. If one pair of the 2k pairs of the left and right gate lines LGL1-LGL2k and RGL1-RGL2k is enabled by the pulses of the gate high voltage VGH, the TFTs connected to the enabled left and right gate lines LGL and RGL are turned on, so that the data voltages from the corresponding data lines DL are transferred to the corresponding liquid crystal cells Clc. When one pair of the scan signals change from the gate high voltage VGH to the gate low voltage VGL, the turned-on TFTs are turned off, so that the corresponding liquid crystal cells Clc are electrically disconnected from the corresponding data lines DL. The liquid crystal cells Clc are charged with the data voltage supplied from the corresponding data lines DL during the turn-on period of the TFTs, and the charged data voltages are maintained until the corresponding TFTs are turned on again.

The gate driver 104 and the first and second data drivers 106A and 106B write the data voltage to the liquid crystal cells of the liquid crystal panel 102 once for the frame period, that is, for period of the vertical sync signal.

Referring to FIG. 4, the LCD includes a timing controller 208 for controlling the first and second gate drivers 204A and 204B and the data driver 206, and a backlight unit 210 for irradiating light onto the liquid crystal panel 202. The timing controller 208 generates the gate control signals for controlling the first and second gate drivers 204A and 204B and the data control signals for controlling the data driver 206 by using vertical/horizontal sync signals (Vsync/Hsync), data enable signal (DE), and clock signal, which are generated from an external system (not shown), such as graphic card of computer system or TV signal decoder module of television receiver. In response to the gate control signals generated from the timing controller 208, the first and second gate drivers 204A and 204B enable the 2k pairs of left and right gate lines LGL1-LGL2k and RGL1-RGL2k arranged on the left and right portions C and D of the liquid crystal panel 202 to be sequentially driven once for period of one vertical sync signal, that is, for frame period. In response to the data control signals, the data driver 206 supplies the one-line data voltages to the data lines DL1-DL2j in a line by line fashion whenever any one pair of the 2k pairs of the left and right gate lines LGL1-LGL2k and RGL1-RGL2k is enabled.

In addition, the timing controller 208 arranges the R, G and B pixel data supplied from the external system line by line, and supplies the one-line R, G and B pixel data to the data driver 206 in each period of the horizontal sync signal. The data driver 206 converts the one-line R, G and B pixel data into analog data voltages. The one-line data voltages converted by the data driver 206 are simultaneously supplied to the data lines DL1-DL2j.

The backlight unit 210 includes first to eighth lamps 213A to 213H arranged in parallel under the liquid crystal panel 202. The first to fourth lamps 213A to 213D are arranged to correspond to the upper portion A of the liquid crystal panel 202, while the fifth to eighth lamps 213E to 213H are arranged to correspond to the lower portion B of the liquid crystal panel 202. The first to fourth lamps 213A to 213D irradiate light respectively onto sub-sections defined by dividing the upper portion A of the liquid crystal panel 202 by four. For example, the first lamp 213A irradiates light onto the uppermost sub-section A1 of the upper portion A of the liquid crystal panel 202 and the fourth lamp 213D irradiates light onto the lowermost sub-section A4 of the lower portion A of the liquid crystal panel 202. Likewise, the fifth to eighth lamps 213E to 213H respectively irradiate light onto the sub-sections defined by dividing the lower portion B of the liquid crystal panel 202 by four. For example, the fifth lamp 213E irradiates light onto the uppermost sub-section B1 of the lower portion B of the liquid crystal panel 202 and the eighth lamp 213H irradiates light onto the lowermost sub-section B4 of the lower portion B of the liquid crystal panel 202.

The backlight unit 210 includes first to fourth lamp drivers 215A to 215D commonly connected to the timing controller 208. Each of the first to fourth lamp drivers 215A to 215D turns on and off (in detail, after or before) one of the lamps for the upper portion A of the liquid crystal panel 202 and one of the lamps for the lower portion B of the liquid crystal panel 202 simultaneously twice. In response to the lamp control signals outputted from the timing controller 208, the first to fourth lamp drivers 215A to 215D sequentially turn on and off the first to fourth lamps 213A to 213D for the upper portion A of the liquid crystal panel 202 for a half period of one vertical sync signal in such a way that the turn-on periods are shifted at a predetermined interval. The shift period between the turn-on periods of the lamps may be a period in which the liquid crystal cells Clc on the one sub-section A1 to A4 corresponding to the first to fourth lamp drivers 215A to 215D charge the data voltages. Simultaneously, the first to fourth lamp drivers 215A to 215D turn on the fifth to eighth lamps 213E to 213H for the lower portion B of the liquid crystal panel 202 together with the first to fourth lamps 213A to 213D. Therefore, the fifth to eighth lamps 213E to 213H are sequentially turned on such that the turn-on periods are shifted at predetermined period for a half period of the vertical sync signal, that is, for a half frame period. In other words, there may be differences between the turn-on periods of the lamps 213A-213D or 213E-213H for the sub-sections A1-A4 or B1-B4. Thus, at least one of the lamp driving voltages generated by the first to fourth lamp drivers 215A to 215D have a different duty cycle from the others.

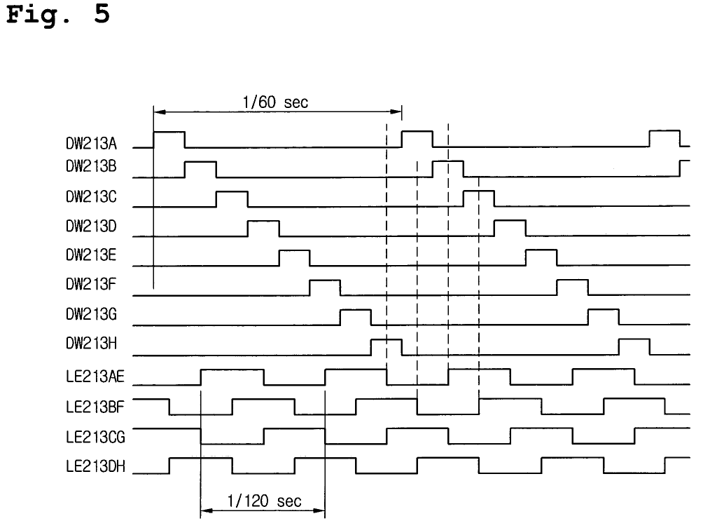

In response to the lamp control signal outputted from the timing controller 208, the first lamp driver 215A turns on and off the first lamp 213A for the uppermost sub-section A1 of the upper portion A of the liquid crystal panel 202 and the fifth lamp 213E for the uppermost sub-section B1 of the lower portion B of the liquid crystal panel 202 simultaneously once for a half period of the vertical sync signal, that is, for a half frame period. The first lamp driver 215A turns off the first and fifth lamps 213A and 213E during the data voltage charging periods (high-voltage periods in DW213A and DW213E of FIG. 5) in which data voltages are charging the liquid crystal cells Clc on the uppermost sub-sections A1 and B 1 of the upper and lower portions A and B of the liquid crystal panel 202, or during the periods (low-voltage periods in LE213AE of FIG. 5) including predetermined intervals before and after the data voltage charging periods. On the other hand, during the periods (low-voltage periods in DW213A and DW213E of FIG. 5) in which the liquid crystal cells Clc on the uppermost sub-sections A1 and B1 of the liquid crystal panel 202 maintain the charged data voltages, the first lamp driver 215A turns on the first and fifth lamps 213A and 213E for a predetermined time (high-voltage period in LE213AE of FIG. 5).

In response to the lamp control signal outputted from the timing controller 208, the second lamp driver 215B turns on and off the second lamp 213B for the second uppermost sub-section A2 of the upper portion A of the liquid crystal panel 202 and the sixth lamp 213F for the second uppermost sub-section B2 of the lower portion B of the liquid crystal panel 202 simultaneously once for a half period of the vertical sync signal, that is, for a half frame period. The second lamp driver 215B turns off the second and sixth lamps 213B and 213F during the periods (high-voltage periods in DW213B and DW213F of FIG. 5) in which the data voltages are charging the liquid crystal cells Clc in the second uppermost sub-sections A2 and B2 of the upper and lower portions A and B of the liquid crystal panel 202, or during the periods (low-voltage periods in LE213BF of FIG. 5) including predetermined intervals before and after the data voltage charging periods. On the other hand, during the periods in which the liquid crystal cells Clc of the second uppermost sub-sections A2 and B2 of the liquid crystal panel 202 maintain the charged data voltages, the second lamp driver 215B turns on the second and sixth lamps 213B and 213F for a predetermined time (high-voltage period in LE213BF of FIG. 5).

In response to the lamp control signal outputted from the timing controller 208, the third lamp driver 215C turns off and on the third lamp 213C for the second lowermost sub-section A3 of the upper portion A of the liquid crystal panel 202 and the seventh lamp 213G for the second lowermost sub-section B3 of the lower portion B of the liquid crystal panel 202 simultaneously once for a half period of the vertical sync signal, that is, for a half frame period. The third lamp driver 215C turns off the third and seventh lamps 213C and 213G during the periods (high-voltage periods in DW213C and DW213G of FIG. 5) in which the data voltages are charging the liquid crystal cells Clc in the second lowermost sub-sections A3 and B3 of the upper and lower portions A and B of the liquid crystal panel 202, or during the periods (low-voltage periods in LE213CG of FIG. 5) including predetermined intervals before and after the data voltage charging periods. On the other hand, during the periods in which the liquid crystal cells Clc of the second lowermost sub-sections A3 and B3 of the liquid crystal panel 202 maintain the charged data voltages, the third lamp driver 215C turns on the third and seventh lamps 213C and 213G for a predetermined time (high-voltage period in LE213CG of FIG. 5).

In response to the lamp control signal outputted from the timing controller 108, the fourth lamp driver 215D turns off and on the fourth lamp 213D for the lowermost sub-section A4 of the upper portion A of the liquid crystal panel 202 and the eighth lamp 213H for the lowermost sub-section B4 of the lower portion B of the liquid crystal panel 202 simultaneously once for a half period of the vertical sync signal, that is, for a half frame period. The fourth lamp driver 215D turns off the fourth and eighth lamps 213D and 213H during the periods (high-voltage periods in DW213D and DW213H of FIG. 5) in which the data voltages are charging the liquid crystal cells Clc in the lowermost sub-sections A4 and B4 of the upper and lower portions A and B of the liquid crystal panel 202, or during the periods (low-voltage periods in LE213DH of FIG. 5) including predetermined intervals before and after the data voltage charging periods. On the other hand, during the periods (low-voltage periods in DW213D and DW213H of FIG. 5) in which the liquid crystal cells Clc of the lowermost sub-sections A4 and B4 of the liquid crystal panel 202 maintain the charged data voltages, the fourth lamp driver 215D turns on the fourth and eighth lamps 213D and 213H for a predetermined time (high-voltage period in LE213DH of FIG. 5).

As can be seen from the timing diagram of FIG. 5, the first to fourth lamp drivers 215A to 215D sequentially turn on and off twice the first to fourth lamps 213A to 213D corresponding to the upper portion A of the liquid crystal panel 202 and the fifth to eighth lamps 213E to 213H corresponding to the lower portion B of the liquid crystal panel 102 in such a way that the first to fourth lamps 213A to 213D are synchronized with the fifth to eighth lamps 213E to 213H in each frame period while lines of liquid crystal cells Clc are sequentially written one at a time. Thus, video data and black level data are alternately displayed twice on the liquid crystal panel 202 at a frame frequency (the second frame frequency of e.g., 120 Hz) that is twice the frame frequency (e.g., the first frame frequency of 60 Hz) of the video data generated from the external system. Therefore, according to embodiments of the present invention, the LCD can respond to the video data quickly. Thus, the motion blurring phenomenon does not occur when a moving picture is displayed.

In addition, the lamps for the sub-sections of the upper portion of the liquid crystal panel and the lamps for the sub-sections of the lower portion of the liquid crystal panel are turned on and off by a single lamp driver. Therefore, the circuit for driving the lamps can be simplified.

In the LCD according to embodiments of the present invention, the gate line for enabling the TFTs for one line is divided into the left gate line and the right gate line, so that the left gate line and the right gate line are individually driven. Therefore, the propagation delay time of the scan signal in the gate line is reduced. Consequently, the LCD according to embodiments of the present invention can respond to the image change rapidly, thereby improving the image quality.

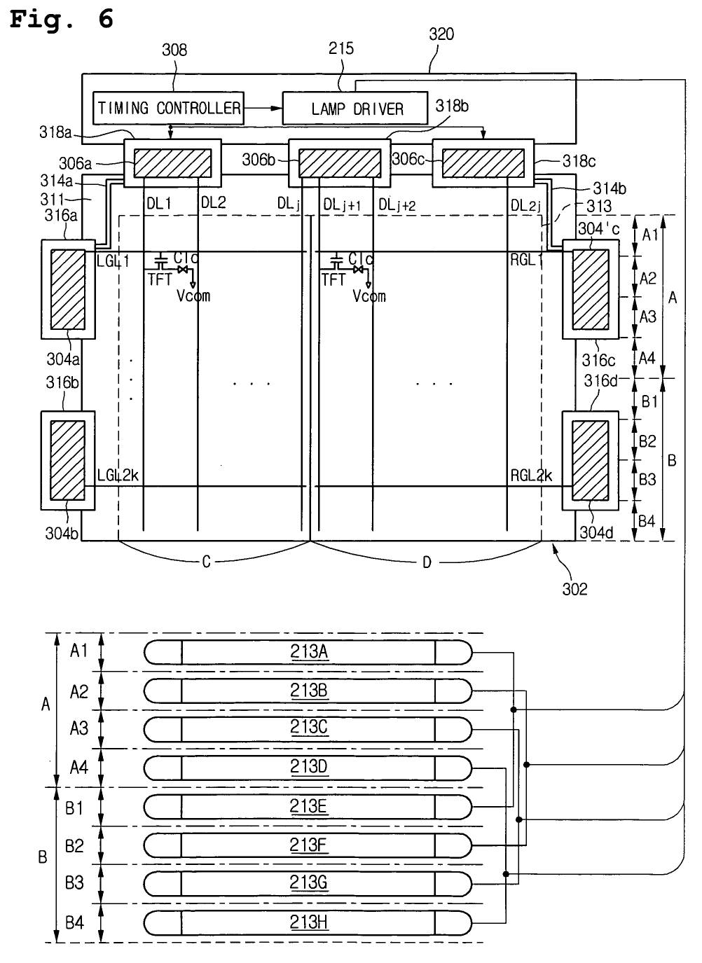

FIG. 6 is a schematic diagram of a Line On Glass (LOG) type LCD according to a third embodiment of the present invention. Referring to FIG. 6, the LCD includes a liquid crystal panel 302 for displaying an image, a plurality of data tape carrier packages (TCPs) 318a to 318c connected between the liquid crystal panel 302 and a data printed circuit board (PCB) 320, a plurality of gate TCPs 316a to 316d provided at one side and another side of the liquid crystal panel 302, a plurality of data driver ICs 306a to 306c mounted on the data TCPs 318a to 318c, and a plurality of gate driver ICs 304a to 304d mounted on the gate TCPs 316a to 316d. The liquid crystal panel 302 includes a lower substrate 311, an upper substrate 313, and a liquid crystal (not shown) injected between the lower substrate 311 and the upper substrate 313. The lower substrate 311 and the upper substrate 313 are transparent insulation substrates. Among the plurality of gate TCPs 316a to 316d, the first and second gate TCPs 316a and 316b are provided at one side of the liquid crystal panel 302. A first LOG type signal line group 314a is disposed on the lower substrate 311 to serially connect the first and second gate driver ICs 304a and 304b mounted on the first and second gate TCPs 316a and 316b. In addition, the third and fourth gate TCPs 316c and 316d are provided at another side of the liquid crystal panel 302. A second LOG type signal line group 314b is disposed on the lower substrate 311 to serially connect the third and fourth gate driver ICs 304c and 304d mounted on the third and fourth TCPs 316c and 316d.

The liquid crystal panel 302 includes a plurality of left gate lines LGL1-LGL2k arranged at a left portion C of the liquid crystal panel 302 in a vertical direction, and a plurality of right gate lines RGL1-RGL2k arranged at a right portion D of the liquid crystal panel 302 in a vertical direction. The left gate lines LGL1-LGL2k are crossed with a first j number of data lines DL1-DLj disposed at the left portion C of the liquid crystal panel 202, and the right gate lines RGL1-RGL2k are crossed with a second j number of data lines DL(k+1)-DL2j arranged at the right portion of the liquid crystal panel 202 in a horizontal direction. The left gate lines LGL1-LGL2k are sequentially driven by the first and second gate driver ICs 304a and 304b, and the right gate lines RGL1-RGL2k are sequentially driven by the third and fourth gate driver ICs 304c and 304d in such a way that they are synchronized with the left gate lines LGL1-LGL2k. The data lines DL1-DL2j are all charged with data voltages when one pair of the left gate line LGL and the right gate line RGL are enabled. The gate lines LGL1-LGL2k and RGL1-RGL2k and the data lines DL 1-DL2j arranged on the liquid crystal panel 302 are driven in the same manner as those of FIG. 4. In other words, the liquid crystal panel 302, the first to fourth gate driver ICs 304a to 304d, and the first to third data driver ICs 306a to 306c connected to thereto are driven in the same manner as those of FIG. 4. Therefore, detailed description about the liquid crystal panel 302, the first to fourth gate driver ICs 304a to 304d, and the first to third data driver ICs 306a to 306c will be omitted.

The LOG type LCD of FIG. 6 includes first to eighth lamps 213A to 213H arranged in parallel under the liquid crystal panel 302, a timing controller 308 mounted on the data PCB 320, and a lamp driver 215. The first to fourth lamps 213A to 213D are arranged to correspond to the upper portion A of the liquid crystal panel 302, while the fifth to eighth lamps 213E to 213H are arranged to correspond to the lower portion B of the liquid crystal panel 302. The first to fourth lamps 213A to 213D respectively irradiate light onto sub-sections defined by dividing the upper portion A of the liquid crystal panel 302 by four. For example, the first lamp 213A irradiates light onto the uppermost sub-section A1 in the upper portion A of the liquid crystal panel 302, and the fourth lamp 213D irradiates light onto the lowermost sub-section A4 in the lower portion A of the liquid crystal panel 302. Likewise, the fifth to eighth lamps 213E to 213H respectively irradiate light onto sub-sections defined by dividing the lower portion B of the liquid crystal panel 302. For example, the fifth lamp 213E irradiates light onto the uppermost sub-section B1 of the lower portion B of the liquid crystal panel 302, and the eighth lamp 213H irradiates light onto the lowermost sub-section B4 of the lower portion B of the liquid crystal panel 302.

In response to the lamp control signals outputted from the timing controller 308, the lamp driver 215 turns on and off the lamps 213A to 213D for the upper portion A of the liquid crystal panel 302 and the lamps 213E to 213H for the lower portion B of the liquid crystal panel 302 simultaneously and sequentially once for a half period of the vertical sync signal, that is, a half frame period. The first to fourth lamps 213A to 213D are sequentially turned off and on in such a way that their turn-on periods are shifted at predetermined interval. The shift period between the turn-on periods of the first to fourth lamps 213A to 213D corresponds to the periods in which the liquid crystal cells Clc on one sub-section charge data voltages. The fifth to eighth lamps 213E to 213H for the lower portion B of the liquid crystal panel 302 are simultaneously turned on and off together with the first to fourth lamps 213A to 213D, respectively. Therefore, the fifth to eighth lamps 213E to 213H are sequentially turned on once, such that the turn-on periods are shifted at predetermined interval for a half period of the vertical sync signal, that is, for a half frame period. To drive the first to eighth lamps 213A to 213H in the above-described manner, the lamp driver 215 includes the first to fourth lamp drivers 215A to 215D of FIG. 4. Since the lamp driver 215 and the first to eighth lamps 213A to 213H are similar to those described in the detailed description of FIG. 4, a detailed description about the lamp driver will be omitted.

As can be seen from the timing diagram of FIG. 5, the timing controller 308 controls the gate driver ICs 304a to 304d and the data drivers 306a to 306c for sequentially writing data voltages, based on a line, to all liquid crystal cells Clc of the liquid crystal panel 302 once in every frame, and controls the lamp driver 215 for turning on and off the first to eighth lamps 213A to 213H twice. Since the timing controller 308 is similar to the one described in the detailed description of FIG. 4, detailed description about the timing controller 308 will be omitted.

As can be seen from the timing diagram of FIG. 5, the LOG type LCD of FIG. 6 sequentially turns on and off twice the first to fourth lamps 213A to 213D for the upper portion A of the liquid crystal panel 302 and the fifth to eighth lamps 213E to 213H for the lower portion B of the liquid crystal panel 302 in such a way that the first to fourth lamps 213A to 213D are synchronized with the fifth to eighth lamps 213E to 213H, during one frame period in which the data are written once to all the liquid crystal cells Clc of the liquid crystal panel 302. In other words, video data and black level data are alternately displayed on the liquid crystal panel 302 at the frame frequency (the second frame frequency of e.g., 120 Hz) that is twice the frame frequency (e.g., the first frame frequency of 60 Hz) of the video data generated from the external system. Therefore, the LOG type LCD according to embodiments of the present invention can respond to the video data quickly. Thus, the motion blurring phenomenon does not occur when a moving picture is displayed.

In addition, the lamps for the sub-sections of the upper portion and the lamps for the sub-sections of the lower portion are turned on and off by a single lamp driver. Therefore, the circuit for driving the lamps can be simplified.

In the LOG type LCD according to the third embodiment, the gate line for enabling the TFTs for one line is divided into the left gate line and the right gate line, so that the left gate line and the right gate line are individually driven. Therefore, the propagation delay time of the scan signal in the gate line is reduced. Consequently, the LOG type LCD according to embodiments of the present invention can respond to the image change rapidly, thereby improving the image quality.

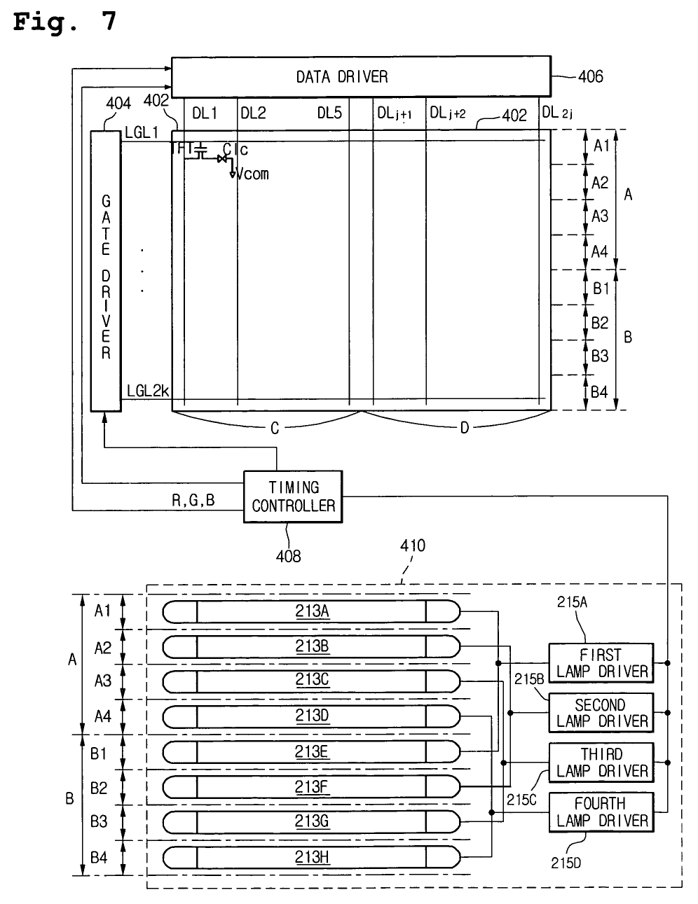

FIG. 7 is a schematic diagram of an LCD according to a fourth embodiment of the present invention. Referring to FIG. 7, the LCD according to the fourth embodiment of the present invention includes a gate driver 404 for driving a plurality of gate lines GL1-GL2k disposed on the liquid crystal panel 402, and a data driver 406 for driving a plurality of data lines DL1-DL2j disposed on the liquid crystal panel 402.

The gate lines GL1-GL2k are arranged on the liquid crystal panel 402 and cross the data lines DL1 to DL2j arranged in a horizontal direction. TFTs acting as switching elements are formed at crossings between the data lines DL1-DL2j and the gate lines GL1-GL2k. In response to scan signals applied on the corresponding gate lines GL, the TFTs switch data voltages supplied from the corresponding data lines DL to liquid crystal cells Clc connected to common voltage lines Vcom. The liquid crystal cells Clc of the liquid crystal panel 402 transmit light proportionally to a potential difference between the data voltages of the data lines DL and the reference voltage, that is, the common voltage Vcom.

The gate driver 404 generates the scan signals supplied to the gate lines GL1-GL2k in response to the gate control signals in each period of one vertical sync signal, that is, in each frame period. The scan signals from the gate driver 404 enable a 2k number of gate lines GL1 to GL2k to be sequentially driven once for period of one vertical sync signal. To this end, the 2k number of scan signals supplied to the 2k number of the gate lines GL1-GL2k arranged on the liquid crystal panel 402 exclusively has shifted pulses of gate high voltage VGH. The pulse of the gate high voltage VGH contained in the scan signal has a width equal to the period of one horizontal sync signal.

The data driver 406 converts R, G and B pixel data corresponding to one line into analog data voltages in response to the data control signals in each period of the horizontal sync signal, and supplies the one-line data voltages to the data lines DL1-DL2j arranged on the liquid crystal panel 402. Specifically, the data driver 406 outputs the one-line data voltages whenever any one of the 2k number of the gate lines GL1-GL2k is enabled, that is, in each period of one horizontal sync signal. When one of the gate lines GL1-GL2k is enabled by the pulse of the gate high voltage VGH, the TFTs connected to the enabled gate lines GL are turned on, so that the data voltages from the corresponding data lines DL are transferred to the corresponding liquid crystal cells Clc. When the scan signal changes from the gate high voltage VGH to the gate low voltage VGL, the turned-on TFT is turned off, so that the corresponding liquid crystal cell Clc is electrically disconnected from the corresponding data line DL. The liquid crystal cell Clc charges the data voltage supplied from the corresponding data line DL during the turn-on period of the TFT, and the charged data voltage is maintained until the corresponding TFT is turned on again.

The gate driver 404 and the data driver 406 write once the data voltage to the liquid crystal cells of the liquid crystal panel 402 in each frame period, that is, in each period of the vertical sync signal.

Referring to FIG. 7, the LCD includes a timing controller 408 for controlling the gate driver 404 and the data driver 406, and a backlight unit 410 for irradiating light onto the liquid crystal panel 402. The timing controller 408 generates the gate control signals for controlling the gate driver 404 and the data control signals for controlling the data driver 406 by using vertical/horizontal sync signals (Vsync/Hsync), data enable signal (DE), and clock signal, which are generated from an external system (not shown), such as graphic card of computer system or TV signal decoder module of television receiver. In response to the gate control signals generated from the timing controller 408, the gate driver 404 sequentially drives the 2k number of the gate lines GL1-GL2k arranged on the liquid crystal panel 402. In response to the data control signals generated from the timing controller 408, the data driver 406 supplies the one-line data voltages to the data lines DL1-DL2j line by line.

The timing controller 408 also arranges the R, G and B pixel data supplied from the external system in line by line fashion, and supplies the one-line R, G and B pixel data to the data driver 406 in each period of the horizontal sync signal. Therefore, the data driver 406 converts the one-line R, G and B pixel data into analog data voltages. The one-line data voltages converted by the data driver 406 are simultaneously supplied to the data lines DL1-DL2j.

Like the backlight unit 210 of FIG. 4, the backlight unit 410 includes first to eighth lamps 213A to 213H and first to fourth lamp drivers 215A to 215D. The first to fourth lamps 213A to 213D are arranged to correspond to the upper portion A of the liquid crystal panel 402 while the fifth to eighth lamps 213E to 213H are arranged to correspond to the lower portion B of the liquid crystal panel 402. The first to fourth lamps 213A to 213D respectively irradiate light onto the sub-sections defined by dividing the upper portion A of the liquid crystal panel 402 by four. For example, the first lamp 213A irradiates light onto the uppermost sub-section A1 of the upper portion A of the liquid crystal panel 402, and the fourth lamp 213D irradiates light onto the lowermost sub-section A4 of the lower portion A of the liquid crystal panel 402. Likewise, the fifth to eighth lamps 213E to 213H respectively irradiate light onto sub-sections defined by dividing the lower portion B of the liquid crystal panel 402 by four. In other words, the fifth lamp 213E irradiates light onto the uppermost sub-section B1 of the lower portion B of the liquid crystal panel 402, and the eighth lamp 213H irradiates light onto the lowermost sub-section B4 of the lower portion B of the liquid crystal panel 402.

In response to the lamp control signals outputted from the timing controller 408, the first to fourth lamp drivers 215A to 215D simultaneously and sequentially turn off and on twice the lamps 213A to 213D for the upper portion A of the liquid crystal panel 402 together with the lamps 213E to 213H for the lower portion B of the liquid crystal panel 402, for period of one vertical sync signal. In response to the lamp control signals outputted from the timing controller 208, the first to fourth lamp drivers 215A to 215D sequentially turn off and on once the first to fourth lamps 213A to 213D in each half period of the vertical sync signal, that is, in each half frame period, in such a way that the turn-on periods are shifted at predetermined interval. The shift period between the turn-on periods of the first to fourth lamps 213A to 213D may be period in which the liquid crystal cell Clc on sub-sections A1 to A4 of the liquid crystal panel 402 charge the data voltages. Simultaneously, the fifth to eighth lamps 213E to 213H for the lower portion B of the liquid crystal panel 402 are turned on together with the first to fourth lamps 213A to 213D, respectively. Therefore, the fifth to eighth lamps 213E to 213H are sequentially turned on once for a half period of the vertical sync signal, that is, for a half frame period, in such a way that the turn-on periods are sequentially shifted at predetermined interval. In other words, there may be differences between the turn-on periods of the lamps 213A-213D or 213E-213H for the sub-sections A1-A4 or B1-B4 of the liquid crystal panel 402. Thus, at least one of the lamp driving voltages generated by the first to fourth lamp drivers 215A to 215D has a different duty cycle from the others. Since the first to fourth lamp drivers 215A to 215D and the first to eighth lamps 213A to 213H are similar to those described with reference to FIG. 4, their detailed description will be omitted.

As can be seen from the timing diagram of FIG. 5, the LOG type LCD of FIG. 7 sequentially turns on and off twice the first to fourth lamps 213A to 213D for the upper portion A of the liquid crystal panel 402 and the fifth to eighth lamps 213E to 213H for the lower portion B of the liquid crystal panel 402 in such a way that the first to fourth lamps 213A to 213D are synchronized with the fifth to eighth lamps 213E to 213H, during one frame period in which the video data is written one at a time to all the liquid crystal cells Clc of the liquid crystal panel 402. In other words, video data and black level data are alternately displayed on the liquid crystal panel 402 at a frame frequency (the second frame frequency of e.g., 120 Hz) that is twice the frame frequency (e.g., the first frame frequency of 60 Hz) of the video data generated from the external system. Therefore, the LOG type LCD according to embodiments of the present invention can respond to the video data quickly. Thus, the motion blurring phenomenon does not occur when a moving picture is displayed. Further, alternating the display of video data and black level data twice on the liquid crystal panel also prevents an unclear image or image-sticking so that the image is presented quickly. Consequently, the LCD according to embodiments of the present invention improves image quality with minimizing a reduction of brightness.

In addition, the lamps for the sub-sections of the upper portion of the liquid crystal panel and the lamps for the sub-sections of the lower portion of the liquid crystal panel are turned on and off by a single lamp driver. Therefore, the circuit for driving the lamps can be simplified.

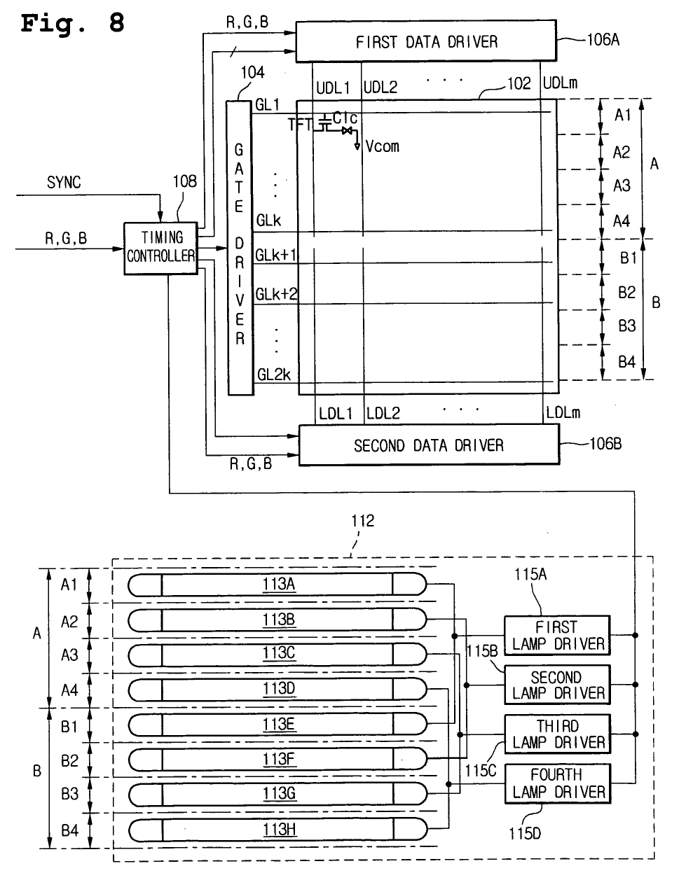

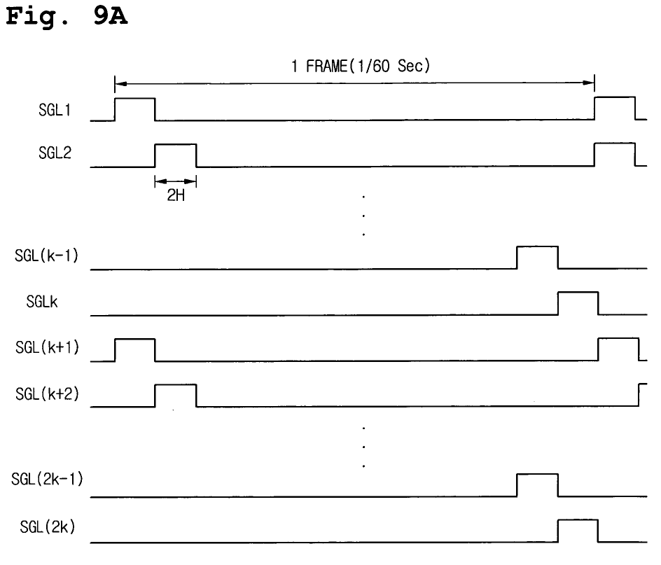

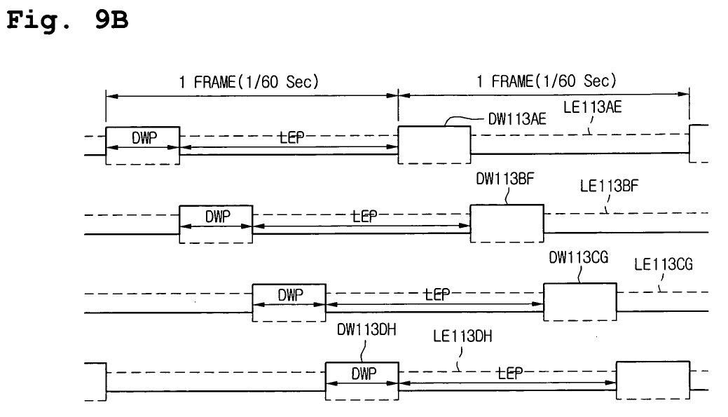

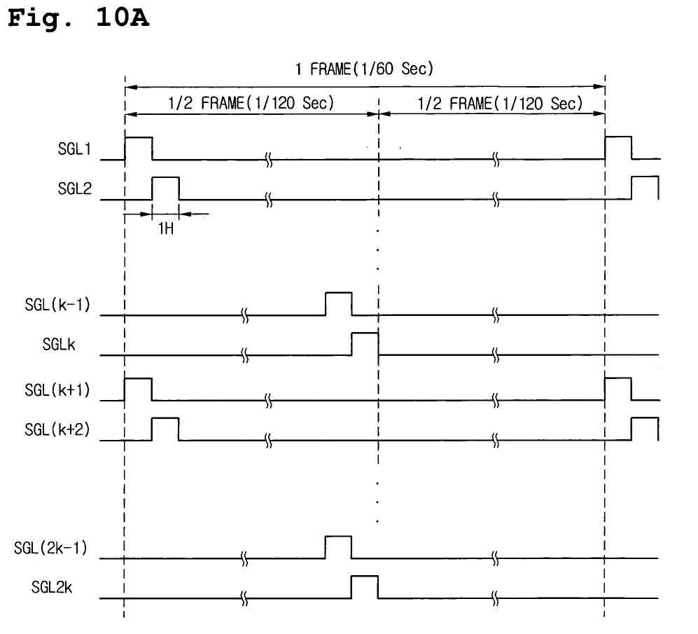

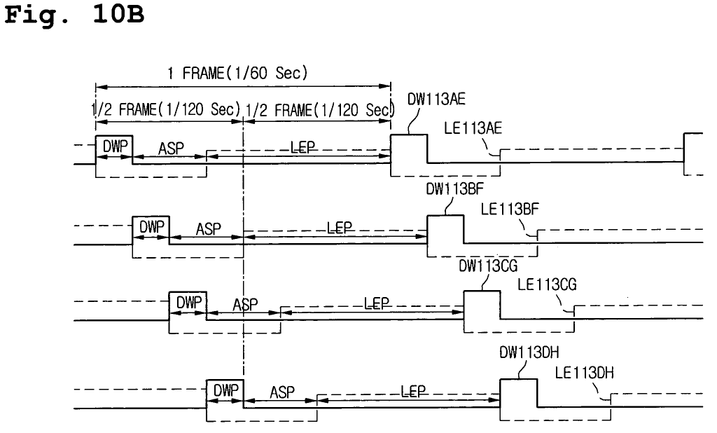

FIG. 8 is a schematic diagram of an LCD according to a fifth embodiment of the present invention. The LCD according to the fifth embodiment of the present invention is similar to the LCD according to the LCD of FIG. 2, except that the data converter 110 is removed and the timing controller 108 directly receives the video data from a system (not shown) such as graphic card of computer system or TV signal decoder module of television receiver. Unlike the LCD of FIG. 2, the liquid crystal panel 102 and the lamps 113A to 113H included in the LCD of FIG. 8 operate at a frame frequency (e.g., 60 Hz) of an original video data. In addition, the liquid crystal panel 102 and the lamps 113A to 113H can be selectively driven in a first driving mode or a second driving mode. In the first driving mode, the LCD of FIG. 8 is driven according to the timing of FIGS. 9A and 9B. In the second driving mode, the LCD of FIG. 8 is driven according to the timing of FIGS. 10A and 10B. For convenience, the operation of the LCD in the second driving mode will be referred to as a sixth embodiment of the present invention. The LCD of FIG. 8 will be described below in detail according to the driving modes.

Referring to FIG. 9A, the gate driver 104 sequentially enables once the gate lines GL1-GLk on the upper portion A of the liquid crystal panel 102 in each frame period of the video data, that is, in each period ( 1/60 sec) of the vertical sync signal. The gate driver 104 sequentially enables once the gate lines GL(k+1)-GL2k on the lower portion B of the liquid crystal panel 102 to be driven in synchronization with the gate lines GL1-GLk. For example, the gate driver 104 enables the first gate line GL1 and the (k+1)^{th} gate line GL(k+1) simultaneously for two periods of the horizontal sync signal, enables the second gate line GL2 and the (k+2)^{th} gate line GL(k+2) simultaneously for two periods of the horizontal sync signal, and enables the third gate line GL3 and the (k+3)^{th} gate line GL(k+3) simultaneously for two periods of the horizontal sync signal. In this way, the k^{th} gate line GLk and the 2k^{th} gate line GL2k are simultaneously enabled for the last two periods of the horizontal sync signal. In other words, the gate driver 104 drives k pairs of a first k number of gate lines GL1-GLk for the upper portion A of the liquid crystal panel 102 and a second k number of gate lines GL(k+1)-GL2k for the lower portion B of the liquid crystal panel 102 by one pair for two periods of the horizontal sync signal. In this end, as illustrated in FIG. 9A, the gate driver 104 supplies the 2k number of the scan signals SGL1-SGL2k to the 2k number of the gate lines GL1-GL2k on the liquid crystal panel 102 in each period of the vertical sync signal, that is, in each frame period, respectively. The 2k number of the scan signals SGL1-SGL2k is divided into a first scan signal group SGL1-SGLk supplied to the first k number of the gate lines GL1-GLk for the upper portion A of the liquid crystal panel 102, and a second scan signal group SGL(k+1)-SGL2k supplied to the second k number of the gate lines GL(k+1)-GL2k for the lower portion B of the liquid crystal panel 102. The first scan signal group SGL1-SGLk has a pulse of gate high voltage VGH with a phase and a width equal to those of the second scan signal group SGL(k+1)-SGL2k. The pulse width of the gate high voltage VGH corresponds to two periods of the horizontal sync signal. The pulse of the gate high voltage VGJ contained in the first scan signal group SGL is sequentially shifted by its own width (e.g., two periods of the horizontal sync signal) as the gate lines GL on the upper portion A of the liquid crystal panel 102 move downward. Likewise, the pulse of the gate high voltage VGH contained in the second scan signal group SGL(k+1)-SGL2k is sequentially shifted by its own width (e.g., two periods of the horizontal sync signal) as the gate lines on the lower portion B of the liquid crystal panel 102 move downwards.

The first data driver 106A converts R, G and B pixel data corresponding to one line into analog data voltages in response to the data control signals, and supplies the one-line data voltages to the upper data lines UDL1-UDLm arranged on the upper portion A of the liquid crystal panel 102. The first data driver 106A outputs the one-line data voltages whenever any one of the k number of the gate lines GL1-GLk on the upper portion A of the liquid crystal panel 102 is enabled. The period in which the first data driver 106A supplies the one-line data voltages to the upper data lines UDL1-UDLm corresponds to two periods of the horizontal sync signal having the width equal to that of the gate high pulse enabling the gate lines GL1-GLk arranged on the upper portion A of the liquid crystal panel 102.

Likewise, the second data driver 106B converts R, G and B pixel data corresponding to one line into analog data voltages in response to the data control signals, and supplies the one-line data voltages to the lower data lines LDL1-LDLm arranged on the lower portion B of the liquid crystal panel 102. The second data driver 106B outputs the one-line data voltages to the lower data lines LDL1-LDLm whenever any one of the gate lines GL(k+1)-GL2k is enabled. The period in which the second data driver 106B supplies the one-line data voltages to the lower data lines LDL1-LDLm corresponds to two periods of the horizontal sync signal having the width equal to that of the gate high pulse enabling the gate lines GL(k+1)-GL2k arranged on the lower portion B of the liquid crystal panel 102.

Since the gate lines GL(k+1)-GL2k are simultaneously enabled together with the gate lines GL 1-GLk, the one-line data voltages from the first data driver 106A and the one-line data voltages from the second data driver 106B are simultaneously supplied to the upper data lines UDL1-UDLm and the lower data lines LDL1-LDLm, respectively. Accordingly, when the one-line liquid crystal cells for the upper portion A of the liquid crystal panel 102 charge the data voltages, the one-line liquid crystal cells for the lower portion B of the liquid crystal panel 102 charge the data voltages. In other words, the liquid crystal cells on the liquid crystal panel 102 are charged with the data voltages two lines by two lines for two periods of the horizontal sync signal by the first and second data drivers 106A and 106B and the gate driver 104. Therefore, the liquid crystal cells Clc on the first and second sub-sections A1 and B1 of the upper and lower portions A and B of the liquid crystal panel 102 are simultaneously charged with the data voltages. Then, the data voltages are written to the liquid crystal cells Clc on the second sub-sections A2 and B2 of the upper and lower portions A and B of the liquid crystal panel 102. Next, the data voltages are simultaneously written to the third sub-sections A3 and B3 of the upper and lower portions A and B of the liquid crystal panel 102. Finally, the data voltages are simultaneously written to the liquid crystal cells on the fourth sub-sections A4 and B4 of the upper and lower portions A and B of the liquid crystal panel 102.

When any one of the first k number of the gate lines GL1-GLk on the upper portion A of the liquid crystal panel 102 is enabled for two periods of the horizontal sync signal by the pulse of the gate high voltage VGH, TFTs connected to the enabled gate lines are turned on so that the data voltages from the upper data lines UDL are transferred to the corresponding liquid crystal cells Clc. When the scan signal changes from the gate high voltage VGH to the gate low voltage VGL, the turned-on TFTs on the upper portion A of the liquid crystal panel 102 are turned off so that the liquid crystal cells Clc are electrically disconnected from the upper data lines UDL. The liquid crystal cells Clc charge the data voltages supplied from the upper data lines UDL during two periods of the horizontal sync signal, that is, during the period in which the TFTs are turned on. Then, the charged data voltages are maintained until the TFTs are turned on again in a next frame period.

Likewise, when any one of the second k number of the gate lines GL(k+1)-GL2k on the lower portion B of the liquid crystal panel 102 is enabled by the pulse of the gate high voltage VGH, TFTs connected to the enabled gate lines are turned on so that the data voltages from the lower data lines LDL are transferred to the corresponding liquid crystal cells Clc. When the scan signal changes from the gate high voltage VGH to the gate low voltage VGL, the turned-on TFTs on the lower portion B of the liquid crystal panel 102 are turned off so that the liquid crystal cells Clc are electrically disconnected from the lower data lines LDL. The liquid crystal cells Clc charge the data voltages supplied from the lower data lines LDL during two periods of the horizontal sync signal, that is, during the period in which the TFTs are turned on. Then, the charged data voltages are maintained until the TFTs are turned on again in a next frame period.

The first and fourth lamp drivers 115A to 115D of the backlight unit 112 commonly connected to the timing controller 108 sequentially turn on and off the lamps 113A to 113D of the sub-sections A1 to A4 of the upper portion A of the liquid crystal panel 102 to be synchronized with the lamps 113E to 113H of the sub-sections B1 to B4 of the lower portion B of the liquid crystal panel 102. Each of the lamps 113A to 113D is turned on and off once in each frame period. The frame period corresponds, for example, to a period of the vertical sync signal. To this end, the first to fourth lamp drivers 115A to 115D control the lamp driving voltages to be supplied to the lamps 113A to 113H. The duty cycle of respective the lamp driving voltages (that is, the ratio of the on-time to the off-time) can be different. The operation and effect of the first to fourth lamp drivers 115 will be described in detail with reference to FIG. 9B.

Referring to FIG. 9B, the waveform “DW113AE” represents the time period for writing the data voltages to the liquid crystal cells Clc arranged on the first sub-sections A1 and B 1 of the upper and lower portions A and B of the liquid crystal panel 102. During the period DW113AE, the liquid crystal cells Clc arranged on the first sub-sections A1 and B1 of the upper and lower portions A and B of the liquid crystal panel 102 charge the data voltages for the first ¼ period of the frame period, that is, for DWP period, and maintain the charged data voltages for the remaining ¾ period of the frame period. The waveform “DW113BF” represents the time period for writing the data voltages to the liquid crystal cells Clc arranged on the second sub-sections A2 and B2 of the upper and lower portions A and B of the liquid crystal panel 102. The liquid crystal cells Clc on the second sub-sections A2 and B2 of the liquid crystal panel 102 charge the data voltages for the second ¼ period of the frame period, that is, for DWP period, and maintain the charged data voltages for the ½ period of the frame period and a ¼ period of a next frame period. The waveform “DW113CG” represents the time period for writing the data voltages to the liquid crystal cells Clc arranged on the third sub-sections A3 and B3 of the upper and lower portions A and B of the liquid crystal panel 102. The liquid crystal cells Clc on the third sub-sections A3 and B3 of the liquid crystal panel 102 charge the data voltages for the third ¼ period of the frame period, that is, for a DWP period, and maintain the charged data voltages for the remaining ¼ period of the frame period and a first ½ period of the next frame period. The waveform “DW113DH” represents the time period for writing the data voltages to the liquid crystal cells Clc arranged on the fourth sub-sections A4 and B4 of the upper and lower portions A and B of the liquid crystal panel 102. The liquid crystal cells Clc on the fourth sub-sections A4 and B4 of the liquid crystal panel 102 charge the data voltages for the last ¼ period of the frame period, that is, for a DWP period, and maintain a ¾ period of the next frame period.

The first lamp driver 115A simultaneously supplies the first lamp driving voltage LE113AE of FIG. 9B to the first lamp 113A and the fifth lamp 113E for the first sub-sections A1 and B1 of the liquid crystal panel 102. The first lamp driving voltage LE113AE generated from the first lamp driver 115A has a low voltage level during the period DWP in which the data voltages are written to the liquid crystal cells Clc on the first sub-sections A1 and B1 of the liquid crystal panel 102, and has a high voltage level during the period LEP in which the liquid crystal cells Clc on the first sub-sections A1 and B1 of the liquid crystal panel 102 maintain the data voltages. The high voltage level period LEP of the first lamp driving voltage LE113AE may be shortened according to an amount of brightness in the first sub-sections A1 and B1 of the liquid crystal panel 102. The first and fifth lamps 113A and 113E commonly responding to the first lamp driving voltage LE113AE outputted from the first lamp driver 115A are simultaneously turned off during the period in which the liquid crystal cells Clc of the first sub-sections A1 and B1 of the liquid crystal panel 102 charge the data voltages, and are turned on in the period in which the liquid crystal cells Clc on the first sub-sections A1 and B1 of the liquid crystal panel 102 maintain the charged data voltages, so that light is irradiated onto the first sub-sections A1 and B1 of the liquid crystal panel 102.

The second lamp driver 115B simultaneously supplies the second lamp driving voltage LE113BF of FIG. 9B to the second lamp 113B and the sixth lamp 113F for the second sub-sections A2 and B2 of the liquid crystal panel 102. The second lamp driving voltage LE113BF generated from the second lamp driver 115B has a low voltage level during the period DWP in which the data voltages are written to the liquid crystal cells Clc on the second sub-sections A2 and B2 of the liquid crystal panel 102, and has a high voltage level during the period LEP in which the liquid crystal cells Clc on the second sub-sections A2 and B2 of the liquid crystal panel 102 maintain the data voltages. The high voltage level period LEP of the second lamp driving voltage LE113BF may be shortened according to an amount of brightness in the second sub-sections A2 and B2 of the liquid crystal panel 102. The second and sixth lamps 113B and 113F commonly responding to the second lamp driving voltage LE113BF outputted from the second lamp driver 115B are simultaneously turned off during the period in which the liquid crystal cells Clc on the second sub-sections A2 and B2 of the liquid crystal panel 102 charge the data voltages, and are turned on in the period in which the liquid crystal cells Clc on the second sub-sections A2 and B2 of the liquid crystal panel 102 maintain the charged data voltages, so that light is irradiated onto the second sub-sections A2 and B2 of the liquid crystal panel 102.

The third lamp driver 115C simultaneously supplies the third lamp driving voltage LE113CG of FIG. 9B to the third lamp 113C and the seventh lamp 113G for the third sub-sections A3 and B3 of the liquid crystal panel 102. The third lamp driving voltage LE113CG generated from the third lamp driver 115C has a low voltage level during the period DWP in which the data voltages are written to the liquid crystal cells Clc on the third sub-sections A3 and B3 of the liquid crystal panel 102, and has a high voltage level during the period LEP in which the liquid crystal cells Clc on the third sub-sections A3 and B3 of the liquid crystal panel 102 maintain the data voltages. The high voltage level period LEP of the third lamp driving voltage LE113CG may be shortened according to an amount of brightness in the third sub-sections A3 and B3 of the liquid crystal panel 102. The third and seventh lamps 113C and 113G commonly responding to the third lamp driving voltage LE113CG outputted from the third lamp driver 115C are simultaneously turned off during the period in which the liquid crystal cells Clc on the third sub-sections A3 and B3 of the liquid crystal panel 102 charge the data voltages, and are turned on in the period in which the liquid crystal cells Clc on the third sub-sections of the liquid crystal panel 102 maintain the charged data voltages, so that light is irradiated onto the third sub-sections A3 and B3 of the liquid crystal panel 102.

The fourth lamp driver 115D simultaneously supplies the fourth lamp driving voltage LE113DH of FIG. 9B to the fourth lamp 113D and the eighth lamp 113H for the fourth sub-sections A4 and B4 of the liquid crystal panel 102. The fourth lamp driving voltage LE113DH generated from the fourth lamp driver 115D has a low voltage level during the period DWP in which the data voltages are written to the liquid crystal cells Clc on the fourth sub-sections A4 and B4 of the liquid crystal panel 102, and has a high voltage level during the period LEP in which the liquid crystal cells Clc on the fourth sub-sections A4 and B4 of the liquid crystal panel 102 maintain the data voltages. The high voltage level period LEP of the four lamp driving voltage LE113DH may be shortened according to an amount of brightness in the fourth sub-sections A4 and B4 of the liquid crystal panel 102. The fourth and eighth lamps 113D and 113H commonly responding to the fourth lamp driving voltage LE113DH outputted from the fourth lamp driver 115D are simultaneously turned off during the period in which the liquid crystal cells Clc of the fourth sub-sections A4 and B4 of the liquid crystal panel 102 charge the data voltages, and are turned on in the period in which the liquid crystal cells Clc on the fourth sub-sections A4 and B4 of the liquid crystal panel 102 maintain the charged data voltages, so that light is irradiated onto the fourth sub-sections A4 and B4 of the liquid crystal panel 102.

To drive the liquid crystal panel 102 and the lamps 113A to 113H as illustrated in FIGS. 9A and 9B, the timing controller 108 supplies the gate control signal to the gate driver 104, the data control signal to the first and second data drivers 106A and 106B, and the lamp control signal to the first to fourth lamp drivers 115A to 115D. In addition, the timing controller 108 divides two-line pixel data to the first and second data drivers 106A and 106B for two periods of the horizontal sync signal. In other words, the timing controller 108 supplies one-line pixel data to the first data driver 106A, and another one-line pixel data to the second data driver 106B for two periods of the horizontal sync signal. To this end, the timing controller 108 responds to vertical/horizontal sync signals (Vsync/Hsync), data enable signal (DE), clock signal, and video data, which are generated from an external system (not shown), such as graphic card of computer system or TV signal decoder module of television receiver. The timing controller 108 generates the gate control signals for the gate driver 104, the data control signals for the first and second data drivers 106A and 106B, and the lamp control signals for the first to fourth lamp drivers 113A to 113D, by using the vertical/horizontal sync signals (Vsync/Hsync), the data enable signal (DE), and the clock signal. In addition, the timing controller 108 arranges the R, G and B pixel data supplied from the external system into a line by line R, G and B pixel data, and supplies the one-line R, G and B pixel data to the first and second data drivers 106A and 106B in each two period of the horizontal sync signals. Therefore, the first data driver 106A converts the one-line R, G and B pixel data into analog data voltages in each two period of the horizontal sync signal. The one-line data voltages converted by the first data driver 106A are simultaneously supplied to the upper data lines UDL1-UDLm. In synchronization with the first data driver 106A, the second data driver 106B converts the one-line R, G and B pixel data into analog data voltages. The one-line data voltages converted by the second data driver 106B are simultaneously supplied to the lower data lines LDL1-LDLm.

The first to fourth lamp drivers 115A to 115D sequentially turn on and off the first to fourth lamps 113A to 113D corresponding to the upper portion A of the liquid crystal panel 102 and the fifth to eighth lamps 113E to 113H corresponding to the lower portion B of the liquid crystal panel 102 in such a way that the first to fourth lamps 113A to 113D are synchronized with the fifth to eighth lamps 113E to 113H in each frame period while the liquid crystal cells Clc are simultaneously written once, as illustrated in FIG. 9B. Thus, video data and black level data are alternately displayed once on the liquid crystal panel 102 in each frame period (e.g., 1/60 sec) of the video data generated from the external system.

Therefore, the LCD according to embodiments of the present invention can respond to the video data quickly. Thus, the motion blurring phenomenon does not occur when a moving picture is displayed. Further, providing charging data voltages simultaneously to two portions of the liquid crystal panel also prevents an unclear image or image-sticking so that the image is presented quickly

In addition, the lamps for the sub-sections of the upper portion of the liquid crystal panel 102 and the lamps for the sub-sections of the lower portion of the liquid crystal panel 102 are turned on and off by a single lamp driver. Therefore, the circuit for driving the lamps can be simplified.

Referring to FIG. 10A, the gate driver 104 sequentially enables once each of the gate lines GL1-GLk for the upper portion A of the liquid crystal panel 102 during a half of each frame period (e.g., 1/60 sec) of the video data. The gate driver 104 sequentially enables once the gate lines GL(k+1)-GL2k for the lower portion B of the liquid crystal panel 102 to be driven in synchronization with the gate lines GL1-GLk. For example, the gate driver 104 enables the first gate line GL1 and the (k+1)^{th} gate line GL(k+1) simultaneously for one period of the horizontal sync signal, enables the second gate line GL2 and the (k+2)^{th} gate line GL(k+2) simultaneously for another period of the horizontal sync signal, and enables the third gate line GL3 and the (k+3)^{th} gate line GL(k+3) simultaneously for yet another period of the horizontal sync signal. In this way, the k^{th} gate line GLk and the 2k^{th} gate line GL2k are simultaneously enabled for the last period of the horizontal sync signal. In other words, the gate driver 104 drives k pairs of a first k number of gate lines GL1-GLk for the upper portion A of the liquid crystal panel 102 and a second k number of gate lines GL(k+1)-GL2k for the lower portion B of the liquid crystal panel 102 pair-wise for each period of the horizontal sync signal. In addition, the gate driver 104 is in an idle mode so that no gate lines are enabled for the remaining half frame period in each frame period of the video data.

To this end, as illustrated in FIG. 10A, the gate driver 104 supplies the 2k number of the scan signals SGL1-SGL2k to the 2k number of the gate lines GL1-GL2k on the liquid crystal panel 102 in each half period of the vertical sync signal, respectively. The 2k number of the scan signals SGL1-SGL2k is divided into a first scan signal group SGL1-SGLk supplied to the first k number of the gate lines GL1-GLk on the upper portion A of the liquid crystal panel 102, and a second scan signal group SGL(k+1)-SGL2k supplied to the second k number of the gate lines GL(k+1)-GL2k on the lower portion B of the liquid crystal panel 102. The first scan signal group SGL1-SGLk has a pulse of gate high voltage with a phase and a width equal respectively to those of the second scan signal group SGL(k+1)-SGL2k. The pulse width of the gate high voltage VGH corresponds to one period of the horizontal sync signal. The pulse of the gate high voltage VGH contained in the first scan signal group SGL is sequentially shifted by its own width (e.g., one period of the horizontal sync signal) as the gate lines GL on the upper portion A of the liquid crystal panel 102 move downward. Likewise, the pulse of the gate high voltage VGH contained in the second scan signal group SGL(k+1)-SGL2k is sequentially shifted by its own width (e.g., one period of the horizontal sync signal) as the gate lines on the lower portion B of the liquid crystal panel 102 move downwards. In addition, the gate driver 104 maintains the 2k number of the scan signals at the gate low voltage VGL for the latter period of the vertical sync signal in each period of the vertical sync signal, so that the operation of writing the data voltage is not performed.

As the gate driver 104 sequentially enables the gate lines GL1-GLk on the upper portion A of the liquid crystal panel 102 in each period of the horizontal sync signal, the first data driver 106A sequentially charges the liquid crystal cells Clc on the upper portion A of the liquid crystal panel 102 with the data voltages for a half period of the vertical sync signal in line by line fashion. Then, the first data driver 106A is set to an idle mode for the latter period of one vertical sync signal. During the half period of one vertical sync signal, that is, during the data voltage write period, the one-line data voltages supplied from the first data driver 106A to the data lines UDL1-UDLm are updated in each period of one horizontal sync signal.

Likewise, as the gate driver 104 sequentially enables the gate lines GL(k+1)-GL2k on the lower portion B of the liquid crystal panel 102 in each period of the horizontal sync signal, the second data driver 106B sequentially charges the liquid crystal cells Clc on the lower portion B of the liquid crystal panel 102 with the data voltages for a half period of the vertical sync signal in line by line fashion. Then, the second data driver 106B is set to an idle mode for the latter period of one vertical sync signal. In synchronization with the one-line data voltages supplied from the first data driver 106A, the one-line data voltages supplied from the second data driver 106B to the data lines LDL1-LDLm are updated in each period of one horizontal sync signal.

The first and second data drivers 106A and 106B and the gate driver 104 sequentially charge the liquid crystal cells for the sub-sections of the upper portion A of the liquid crystal panel 102 and the liquid crystal cells for the sub-sections of the lower portion B of the liquid crystal panel 102 with the data voltages for a half period of the vertical sync signal such that they are synchronized with each other, respectively. For example, the liquid crystal cells on the first sub-section A1 of the upper portion A of the liquid crystal panel 102 and the liquid crystal cells on the first sub-section B1 of the lower portion B of the liquid crystal panel 102 charge the data voltages for a first ⅛ period DWP of one vertical sync signal, and maintains the charged data voltages for the remaining ⅞ period of one vertical sync signal. The liquid crystal cells on the second sub-section A2 of the upper portion A of the liquid crystal panel 102 and the liquid crystal cells on the second sub-section B2 of the lower portion B of the liquid crystal panel 102 charge the data voltages for a second ⅛ period DWP of one vertical sync signal, and maintains the charged data voltages for the remaining 6/8 period of one vertical sync signal and a first ⅛ period of a next vertical sync signal. The liquid crystal cells on the third sub-section A3 of the upper portion A of the liquid crystal panel 102 and the liquid crystal cells on the third sub-section B3 of the lower portion B of the liquid crystal panel 102 charge the data voltages for a third ⅛ period DWP of one vertical sync signal, and maintains the charged data voltages for the remaining ⅝ period of one vertical sync signal and a first ¼ period of the next vertical sync signal. The liquid crystal cells on the fourth sub-section A4 of the upper portion A of the liquid crystal panel 102 and the liquid crystal cells on the fourth sub-section B4 of the lower portion B of the liquid crystal panel 102 charge the data voltages for a fourth ⅛ period DWP of one vertical sync signal, and maintains the charged data voltages for the remaining ½ period of one vertical sync signal and a ⅜ period of a next vertical sync signal.

The first to fourth lamp drivers 115A to 115D of the backlight unit 112, which are commonly controlled by the timing controller 108, sequentially turn on and off the lamps 113A to 113H in each period of the vertical sync signal, that is, for each frame period. Each of the lamps 113A to 113H is turned on and off once in each frame period. The lamps 113A to 113D of the sub-sections A1 to A4 and the lamps 113E to 113H of the sub-sections B1 to B4 are turned on at a time when the alignment saturation period elapses after the liquid crystal cells charge the data voltages. Therefore, the lamp driving voltages supplied from the first to fourth lamp drivers 115A to 115D to the corresponding lamps 113A to 113H can be enabled at the time when the alignment saturation period elapses after the data voltage write period is finished, and can be disabled at the time when the data voltages are written to the sub-sections of the liquid crystal panel 102. The enable period of the lamp driving voltages generated from the lamp drivers 115A to 115D are adjusted within the period except for the data voltage write period of the sub-sections and the alignment saturation period in the period of one vertical sync signal. The operation and effect of the first to fourth lamp drivers 115A to 115D generating the above-described lamp driving voltages will be described in detail with reference to FIG. 10B.

Referring to FIG. 10B, the waveform “DW113AE” represents the time period for writing the data voltages to the liquid crystal cells Clc arranged on the first sub-sections A1 and B1 of the upper and lower portions A and B of the liquid crystal panel 102. The waveform “LE113AE” represents the time period for enabling the first lamp driving signal outputted from the first lamp driver 115A. According to the time periods of DW113AE and LE113AE, the first lamp driving voltage LE113AE from the first lamp driver 115A has a low voltage level during half period of the vertical sync signal, including the first ⅛ period DWP of the vertical sync signal in which the data voltages are charged to the liquid crystal cells Clc of the first sub-sections A1 and B1 of the liquid crystal panel 102 and the alignment saturation period ASP corresponding to the ⅜ period of the vertical sync signal. On the other hand, the first lamp driving voltage LE113AE has a high voltage level during the period (light irradiation period LEP) except for the alignment saturation period ASP in which the liquid crystal molecules are rearranged in an alignment direction corresponding to the data voltage, among the period (ASP+LEP) in which the liquid crystal cells Clc in the first sub-sections A1 and B1 of the liquid crystal panel 102 maintain the data voltages. The light irradiation period LEP corresponds to a half period of one vertical sync signal, and may be shortened according to an amount of brightness in the first sub-sections A1 and B1 of the liquid crystal panel 102. When the light irradiation period LEP is shortened, the alignment saturation period ASP is lengthened as much as the reduced period of the light irradiation period LEP. The first and fifth lamps 113A and 113E commonly responding to the first lamp driving voltage LE113AE outputted from the first lamp driver 115A are simultaneously turned on during half period of the vertical sync signal from the time when the alignment saturation period ASP corresponding to the ⅜ period of the vertical sync signal elapses after the data voltages are written or charged to the liquid crystal cells Clc arranged on the first sub-sections A1 and B1 of the liquid crystal panel 102. Thus, the light is irradiated onto the first sub-sections A1 and B1 of the liquid crystal panel 102. Because the first and fifth lamps 113A and 113E irradiate light after the liquid crystal cells Clc of the first sub-sections A1 and B1 of the liquid crystal panel 102 are aligned in a direction corresponding to the data voltage, the pixel data can be correctly displayed. In addition, the black level data are displayed in the first sub-sections A1 and B1 of the liquid crystal panel 102 during the period in which the first and second lamps 113A and 113E are turned off. Therefore, a pseudo impulse display effect in the first sub-sections A1 and B1 of the liquid crystal panel 102 can be maximized.

In FIG. 10B, the waveform “DW113BF” represents the time period for writing the data voltages to the liquid crystal cells Clc arranged on the second sub-sections A2 and B2 of the upper and lower portions A and B of the liquid crystal panel 102. The waveform “LE113BF” represents the time period for enabling the second lamp driving signal outputted from the second lamp driver 115B. According to the time periods of DW113BF and LE113BF, the second lamp driving voltage LE113BF from the second lamp driver 115B has a low voltage level during a half period of the vertical sync signal, including the second ⅛ period DWP of the vertical sync signal in which the data voltages are charged to the liquid crystal cells Clc of the second sub-sections A2 and B2 of the liquid crystal panel 102 and the alignment saturation period ASP corresponding to the ⅜ period of the vertical sync signal. On the other hand, the second lamp driving voltage LE113BF has a high voltage level during the period (light irradiation period LEP) except for the alignment saturation period ASP in which the liquid crystal molecules are rearranged in an alignment direction corresponding to the data voltage, among the period (ASP+LEP) in which the liquid crystal cells Clc in the second sub-sections A1 and B1 of the liquid crystal panel 102 maintain the data voltages. The light irradiation period LEP corresponds to half period of one vertical sync signal, and may be shortened according to an amount of brightness in the second sub-sections A2 and B2 of the liquid crystal panel 102. When the light irradiation period LEP is shortened, the alignment saturation period ASP is lengthened as much as the reduced period of the light irradiation period LEP. The second and sixth lamps 113B and 113F commonly responding to the second lamp driving voltage LE113BF outputted from the second lamp driver 115B are simultaneously turned on during half period of the vertical sync signal from the time when the alignment saturation period ASP corresponding to the ⅜ period of the vertical sync signal elapses after the data voltages are written or charged to the liquid crystal cells Clc arranged on the second sub-sections A2 and B2 of the liquid crystal panel 102. Thus, the light is irradiated onto the second sub-sections A2 and B2 of the liquid crystal panel 102. Because the second and sixth lamps 113B and 113F irradiate the light after the liquid crystal cells Clc of the second sub-sections A2 and B2 of the liquid crystal panel 102 are aligned in a direction corresponding to the data voltage, the pixel data can be correctly displayed. In addition, the black level data are displayed in the second sub-sections A2 and B2 of the liquid crystal panel 102 during the period in which the second and sixth lamps 113B and 113F are turned off. Therefore, the pseudo impulse display effect in the second sub-sections A2 and B2 of the liquid crystal panel 102 can be maximized.

In FIG. 10B, the waveform “DW113CG” represents the time period for writing the data voltages to the liquid crystal cells Clc arranged on the third sub-sections A3 and B3 of the upper and lower portions A and B of the liquid crystal panel 102. The waveform “LE113CG” represents the time period for enabling the third lamp driving signal outputted from the third lamp driver 115C. According to the time periods of DW113CG and LE113CG, the third lamp driving voltage LE113CG from the third lamp driver 115C has a low voltage level during a half period of the vertical sync signal, including the third ⅛ period DWP of the vertical sync signal in which the data voltages are charged to the liquid crystal cells Clc of the third sub-sections A3 and B3 of the liquid crystal panel 102 and the alignment saturation period ASP corresponding to the ⅜ period of the vertical sync signal. On the other hand, the third lamp driving voltage LE113CG has a high voltage level during the period (light irradiation period LEP) except for the alignment saturation period ASP in which the liquid crystal molecules are aligned corresponding to the data voltage, among the period (ASP+LEP) in which the liquid crystal cells Clc in the third sub-sections A3 and B3 of the liquid crystal panel 102 maintain the data voltages. The light irradiation period LEP corresponds to half period of one vertical sync signal, and may be shortened according to an amount of brightness in the third sub-sections A3 and B3 of the liquid crystal panel 102. When the light irradiation period LEP is shortened, the alignment saturation period ASP is lengthened as much as the reduced period of the light irradiation period LEP. The third and seventh lamps 113C and 113G commonly responding to the third lamp driving voltage LE113CG outputted from the third lamp driver 115C are simultaneously turned on during a half period of the vertical sync signal from the time when the alignment saturation period ASP corresponding to the ⅜ period of the vertical sync signal elapses after the data voltages are written or charged to the liquid crystal cells Clc arranged on the third sub-sections A3 and B3 of the liquid crystal panel 102. Thus, the light is irradiated onto the third sub-sections A3 and B3 of the liquid crystal panel 102. Because the third and seventh lamps 113C and 113G irradiate light after the liquid crystal cells Clc of the third sub-sections A3 and B3 of the liquid crystal panel 102 are aligned in a direction corresponding to the data voltage, the pixel data can be correctly displayed. In addition, the black level data are displayed in the third sub-sections A3 and B3 of the liquid crystal panel 102 during the period in which the third and seventh lamps 113C and 113G are turned off. Therefore, the pseudo impulse display effect in the third sub-sections A3 and B3 of the liquid crystal panel 102 can be maximized.

In FIG. 10B, the waveform “DW113DH” represents the time period for writing the data voltages to the liquid crystal cells Clc arranged on the fourth sub-sections A4 and B4 of the upper and lower portions A and B of the liquid crystal panel 102. The waveform “LE113DH” represents the time period for enabling the fourth lamp driving signal outputted from the fourth lamp driver 115D. According to the timing diagrams of DW113DH and LE113DH, the fourth lamp driving voltage LE113DH from the fourth lamp driver 115D has a low voltage level during a half period of the vertical sync signal, including the fourth ⅛ period DWP of the vertical sync signal in which the data voltages are charged to the liquid crystal cells Clc of the fourth sub-sections A4 and B4 of the liquid crystal panel 102 and the alignment saturation period ASP corresponding to the ⅜ period of the vertical sync signal. On the other hand, the fourth lamp driving voltage LE113DH has a high voltage level during the period (light irradiation period LEP) except for the alignment saturation period ASP in which the liquid crystal molecules are aligned corresponding to the data voltage, among the period (ASP+LEP) in which the liquid crystal cells Clc in the fourth sub-sections A4 and B4 of the liquid crystal panel 102 maintain the data voltages. The light irradiation period LEP corresponds to a half period of one vertical sync signal, and may be shortened according to an amount of brightness in the fourth sub-sections A4 and B4 of the liquid crystal panel 102. When the light irradiation period LEP is shortened, the alignment saturation period ASP is lengthened as much as the reduced period of the light irradiation period LEP. The fourth and eighth lamps 113D and 113H commonly responding to the fourth lamp driving voltage LE113DH outputted from the fourth lamp driver 115D are simultaneously turned on during half period of the vertical sync signal from the time when the alignment saturation period ASP corresponding to the ⅜ period of the vertical sync signal elapses after the data voltages are written or charged to the liquid crystal cells Clc arranged on the fourth sub-sections A4 and B4 of the liquid crystal panel 102. Thus, the light is irradiated onto the fourth sub-sections A4 and B4 of the liquid crystal panel 102. Because the fourth and eighth lamps 113D and 113H irradiate the light after the liquid crystal cells Clc of the fourth sub-sections A4 and B4 of the liquid crystal panel 102 are aligned in a direction corresponding to the data voltage, the pixel data can be correctly displayed. In addition, the black level data are displayed in the fourth sub-sections A4 and B4 of the liquid crystal panel 102 during the period in which the fourth and eighth lamps 113D and 113H are turned off. Therefore, the pseudo impulse display effect in the fourth sub-sections A4 and B4 of the liquid crystal panel 102 can be maximized.

The timing controller 108 controls the gate driver 104 and the first and second data drivers 106A and 106B so that the data voltages are writen to the liquid crystal cells of the liquid crystal panel 102 during half frame period, as illustrated in FIGS. 10A and 10B. Meanwhile, upon a controlling of the timing controller 108, the lamp drivers drive the lamps 113A to 113H to be sequentially turned on and off once in each frame period. To this end, the timing controller 108 supplies the gate control signal to the gate driver 104, the data control signal to the first and second data drivers 106A and 106B, and the lamp control signal to the first to fourth lamp drivers 115A to 115D. In addition, the timing controller 108 supplies two-line pixel data to the first and second data drivers 106A and 106B for one period of the horizontal sync signal. In other words, the timing controller 108 supplies the one-line pixel data to the first data driver 106A, and the one-line pixel data to the second data driver 106B for one period of the horizontal sync signal. To this end, the timing controller 108 responds to vertical/horizontal sync signals (Vsync/Hsync), data enable signal (DE), clock signal, and video data, which are generated from an external system (not shown), such as a graphic card of computer system or a TV signal decoder module from a television receiver. The timing controller 108 generates the gate control signals for the gate driver 104, the data control signals for the first and second data drivers 106A and 106B, and the lamp control signals for the first to fourth lamp drivers 113A to 113D, by using the vertical/horizontal sync signals (Vsync/Hsync), the data enable signal (DE), and the clock signal. In addition, the timing controller 108 arranges the R, G and B pixel data supplied from the external system into line by line R, G and B pixel data, and supplies the one-line R, G and B pixel data to the first and second data drivers 106A and 106B in each period of the horizontal sync signals.

Therefore, the first data driver 106A converts the one-line R, G and B pixel data into analog data voltages in each period of the horizontal sync signal. The one-line data voltages converted by the first data driver 106A are simultaneously supplied to the upper data lines UDL1-UDLm. In synchronization with the first data driver 106A, the second data driver 106B converts the one-line R, G and B pixel data into analog data voltages. The one-line data voltages converted by the second data driver 106B are simultaneously supplied to the lower data lines LDL1-LDLm. As illustrated in FIG. 10B, the first to fourth lamp drivers 115A to 115D controlled by the timing controller 108 turn on the first to fourth lamps 113A to 113D from the time when the alignment saturation period ASP elapses after the data voltages are written to the sub-sections A1 to A4 of the liquid crystal panel 102 to the time when the data voltages start to be written to the sub-sections A1 to A4 of the liquid crystal panel 102. In addition, the first to fourth lamp drivers 115A to 115D turn on and off the fifth to eighth lamps 113E to 113H to be synchronized (simultaneously) with the first to fourth lamps 113A to 113D. Therefore, the fifth to eighth lamps 113E to 113H are turned on from the time when the alignment saturation period ASP elapses after the data voltages are written to the sub-sections B1 to B4 of the liquid crystal panel 102 to the time when the data voltages start to be written to the sub-sections B1 to B4 of the liquid crystal panel 102.

The timing controller 108 controls the first to fourth lamp drivers in that light irradiates onto the sub-sections of the liquid crystal panel 102 from the time after the liquid crystal molecules are aligned in a direction corresponding to the data voltage after the data voltages are written to the lamps 113A to 113H. Therefore, while the lamps 113A to 113H are turned on, the liquid crystal panel 102 correctly displays the image corresponding to the video data (data voltages) on the sub-sections. On the other hand, while the lamps 113A to 113H are turned off, the black level data are displayed on the sub-sections corresponding to the lamps 113 to 113H.

In this way, the black level image and the image corresponding to the video data are correctly displayed once because the lamps 113A to 113H are turned on and off once in each frame, thereby maximizing the pseudo impulse driving effect. Therefore, the LCD according to embodiments of the present invention can respond to the video data quickly. In addition, the motion blurring phenomenon does not occur when a moving picture is displayed. Further, it is possible to prevents an unclear image or image-sticking. Thus, the LCD according to embodiments of the present invention can display the high quality image.

Moreover, the lamps for the sub-sections of the upper portion of the liquid crystal panel and the lamps for the sub-sections of the lower portion of the liquid crystal panel are turned on and off by a single lamp driver. Therefore, the circuit for driving the lamps can be simplified.

Thus, video data and black level data are alternately displayed twice on the liquid crystal panel 202 at a frame frequency (the second frame frequency of e.g., 120 Hz) that is twice the frame frequency (e.g., the first frame frequency of 60 Hz) of the video data generated from the external system. Therefore, the LCD according to embodiments of the present invention can respond to the video data quickly. Thus, the motion blurring phenomenon does not occur when a moving picture is displayed. Further, providing charging data voltages simultaneously to two portions of the liquid crystal panel also prevents an unclear image or image-sticking so that the image is presented quickly

In addition, the lamps for the sub-sections of the upper portion of the liquid crystal panel and the lamps for the sub-sections of the lower portion of the liquid crystal panel are turned on and off by a single lamp driver. Therefore, the circuit for driving the lamps can be simplified.

As described above, in the LCD and the driving method thereof according to embodiments of the present invention, video data and black level data are alternately displayed at least once on the liquid crystal panel at a frame frequency (the second frame frequency of e.g., 120 Hz) that is at least twice the frame frequency (e.g., the first frame frequency of 60 Hz) of the video data generated from the external system. Therefore, the LCD according to embodiments of the present invention can respond to the video data quickly. Thus, the motion blurring phenomenon does not occur when a moving picture is displayed. Further, alternating the display of video data and black level data on the liquid crystal panel in each frame period also prevents an unclear image or image-sticking so that the image is presented quickly while minimizing a reduction of brightness.

In addition, the lamps for the sub-sections of the upper portion of the liquid crystal panel and the lamps for the sub-sections of the lower portion of the liquid crystal panel are turned on and off by a single lamp driver. Therefore, the circuit for driving the lamps can be simplified.

It will be apparent to those skilled in the art that various modifications and variations can be made in the liquid crystal display device and driving method thereof of embodiments of the present invention. Thus, it is intended that embodiments of the present invention cover the modifications and variations of the embodiments described herein provided they come within the scope of the appended claims and their equivalents.

What is claimed is:

1. A liquid crystal display device, comprising:
a liquid crystal panel having first data lines crossing gate lines on a first region of the liquid crystal panel and second data lines crossing the gate lines on a second region of the liquid crystal panel;
a data converter for converting a first video data having a first frame frequency into a second video data having a second frame frequency, which is higher than the first frame frequency;
a backlight unit having a first lamp group with at least two lamps for respectively irradiating light onto sub-regions of the first region and a second lamp group with at least two lamps respectively irradiating light on sub-regions of the second region; and
a driver for driving the gate lines, the first data lines and the second data lines in accordance with the second video data and for driving the first and second lamp groups at the second frame frequency so that the lamps of the first lamp group are sequentially turned on and off in synchronization with the lamps of the second lamp group.

2. The liquid crystal display device according to claim 1, wherein the driver includes:
a gate driver for simultaneously driving the gate lines on the first and second regions so that the gate lines on the second region are sequentially enabled in synchronization with the gate lines on the first region;
a first data driver for driving the first data lines on the first region;
a second data driver for driving the second data lines on the second region; and
a timing controller responsive to the second video data for controlling the gate driver, the first data driver and the second data driver and enabling the lamps of the first and second lamp groups to be sequentially turned on and off in synchronization with each other.

3. The liquid crystal display device according to claim 2, wherein the backlight unit includes at least two lamp drivers being controlled by the timing controller and generating lamp driving voltages for enabling the lamps of the first and second lamp groups to be sequentially driven in synchronization with each other.

4. The liquid crystal display device according to claim 3, wherein the lamp driving voltages have different duty cycles.

5. The liquid crystal display device according to claim 4, wherein the second frame frequency is at least twice the first frame frequency.

6. A liquid crystal display device, comprising:
a liquid crystal panel having gate lines and data lines crossing each other;
a backlight unit having a first lamp group with at least two lamps for divisionally irradiating light on a first region of the liquid crystal panel and a second lamp group with at least two lamps divisionally irradiating light on a second region of the liquid crystal panel; and
a driver for driving the gate lines and data lines in accordance with a video data having a first frame frequency and for controlling the first and second lamp groups to be simultaneously driven at a second frame frequency higher than the first frame frequency so that the lamps of the first lamp group are sequentially turned on and off in synchronization with the lamps of the second lamp group.

7. The liquid crystal display device according to claim 6, wherein the driver includes:
a gate driver for driving the gate lines;
a data driver for driving the data lines; and
a timing controller responsive to the video data having the first frame frequency for controlling the gate driver and the date driver and enabling the lamps of the first and second lamp groups to be sequentially turned on and off in synchronization with each other.

8. The liquid crystal display device according to claim 7, wherein the backlight unit includes at least two lamp drivers being controlled by the timing controller and generating lamp driving voltages for enabling the lamps of the first and second lamp groups to be sequentially driven in synchronization with each other.

9. The liquid crystal display device according to claim 8, wherein the lamp driving voltages have different duty cycles.

10. The liquid crystal display device according to claim 6, wherein the second frame frequency is at least twice the first frame frequency.

11. The liquid crystal display device according to claim 6, wherein the gate lines include:
first gate lines crossing the data lines on a third region occupying parts of the first and second regions; and
second gate lines crossing the data lines on a fourth region occupying remaining parts of the first and second regions.

12. The liquid crystal display device according to claim 11, wherein the driver includes:
a first gate driver for driving the first gate lines;
a second gate driver for driving the second gate lines in synchronization with the first gate lines;
a data driver for driving the data lines; and
a timing controller responsive the video data having the first frame frequency for controlling the first and second gate drivers and the date driver and enabling the lamps of the first and second lamp groups to be sequentially turned on and off in synchronization with each other.

13. The liquid crystal display device according to claim 12, wherein the backlight unit includes at least two lamp drivers being controlled by the timing controller and generating lamp driving voltages for enabling the lamps of the first and second lamp groups to be sequentially driven in synchronization with each other.

14. The liquid crystal display device according to claim 13, wherein the lamp driving voltages have different duty cycles.

15. The liquid crystal display device according to claim 11, wherein the second frame frequency is at least twice the first frame frequency.

16. A liquid crystal display device, comprising:
a liquid crystal panel having first data lines crossing gate lines on a first region of the liquid crystal panel and second data lines crossing the gate lines on a second region of the liquid crystal panel;
a backlight unit having a first lamp group with at least two lamp for respectively irradiating light onto sub-regions of the first region and a second lamp group with at least two lamps respectively irradiating light on sub-regions of the second region; and
a driver for driving the gate lines and the data lines to simultaneously write data voltages of a video data to liquid crystal cells of the first region and liquid crystal cells of the second region in each frame in line by line fashion, and for driving the first and second lamp groups so that the at least two lamps of the first lamp group are sequentially turned on and off once in synchronization with the at least two lamps of the second lamp group.

17. The liquid crystal display device according to claim 16, wherein the gate lines on the first region and the gate lines on the second region are sequentially enabled in each two period of a horizontal sync signal in synchronization with each other.

18. The liquid crystal display device according to claim 17, wherein the driver includes:
a gate driver for simultaneously driving the gate lines on the first and second regions so that the gate lines on the second region are sequentially enabled in synchronization with the gate lines on the first region;
a first data driver for driving the first data lines on the first region;
a second data driver for driving the second data lines on the second region; and
a timing controller responsive to the video data for controlling the gate driver, the first data driver and the second data driver and enabling the lamps of the first and second lamp groups to be sequentially turned on and off in synchronization with each other.

19. The liquid crystal display device according to claim 18, wherein the backlight unit includes at least two lamp drivers being controlled by the timing controller and generating lamp driving voltages for enabling the lamps of the first and second lamp groups to be sequentially driven in synchronization with each other.

20. The liquid crystal display device according to claim 18, wherein the lamp driving voltages have different duty cycles.

21. A liquid crystal display device, comprising:
a liquid crystal panel having first data lines crossing gate lines on a first region of the liquid crystal panel and second data lines crossing the gate lines on a second region of the liquid crystal panel;
a backlight unit having a first lamp group with at least two lamps for respectively irradiating light onto sub-regions of the first region and a second lamp group with at least two lamps respectively irradiating light on sub-regions of the second region; and
a driver for operating the gate lines and the data lines to simultaneously write data voltages of a video data to liquid crystal cells of the first region and liquid crystal cells of the second region in each frame in a line by line manner, and for driving the first and second lamp groups so that the lamps of the first and second lamp groups are turned on and off at time when an alignment saturation period elapses after the data voltages are written to liquid crystal cells of the corresponding sub-regions.

22. The liquid crystal display device according to claim 21, wherein the gate lines on the first region and the gate lines on the second region are sequentially enabled in each period of one horizontal sync signal in synchronization with each other.

23. The liquid crystal display device according to claim 22, wherein the gate lines on the first region and the gate lines on the second region are sequentially enabled once in synchronization with each other during a half frame period in each frame.

24. The liquid crystal display device according to claim 23, wherein the driver includes:
a gate driver for simultaneously driving the gate lines on the first and second regions so that the gate lines on the second region are sequentially enabled in synchronization with the gate lines on the first region;
a first data driver for driving the first data lines on the first region;
a second data driver for driving the second data lines on the second region; and
a timing controller responsive to the video data for controlling the gate driver, the first data driver and the second data driver and enabling the lamps of the first and second lamp groups to be sequentially turned on and off in synchronization with each other.

25. The liquid crystal display device according to claim 24, wherein the backlight unit includes at least two lamp drivers being controlled by the timing controller and generating lamp driving voltages for enabling the lamps of the first and second lamp groups to be sequentially driven in synchronization with each other.

26. The liquid crystal display device according to claim 25, wherein the lamp driving voltages have different duty cycles.

27. A liquid crystal display device, comprising:
a liquid crystal panel having gate lines and data lines crossing each other;
a backlight unit having a first lamp group with at least two lamps for divisionally irradiating light on a first region of the liquid crystal panel and a second lamp group with at least two lamps for divisionally irradiating light on a second region of the liquid crystal panel; and
a driver for driving the gate lines and data lines to sequentially write data voltages of a video data to liquid crystal cells of the liquid crystal panel in each frame in line by line manner, and for controlling the first and second lamp groups to be sequentially turned on and off once in synchronization with each other.

28. The liquid crystal display device according to claim 27, wherein the driver includes:
a gate driver for sequentially driving the gate lines once in each frame;
a data driver for driving the data lines; and
a timing controller responsive to the video data for controlling the gate driver and the date driver and enabling the lamps of the first and second lamp groups to be sequentially turned on and off once in synchronization with each other.

29. The liquid crystal display device according to claim 28, wherein the backlight unit includes at least two lamp drivers being controlled by the timing controller and generating lamp driving voltages for enabling the lamps of the first and second lamp groups to be sequentially driven in synchronization with each other.

30. The liquid crystal display device according to claim 29, wherein the lamp driving voltages have different duty cycles.

31. A method of driving a liquid crystal display device with a liquid crystal panel having first data lines crossing gate lines on a first region of the liquid crystal panel, and second data lines crossing the gate lines on a second region of the liquid crystal panel, comprising:
converting a first video data having a first frame frequency into a second video data having a second frame frequency higher than the first frame frequency;
driving the gate lines, the first and second data lines in accordance with the second video data; and
controlling the first and second lamp groups to turn-on and turn-off simultaneously at the second frame frequency, the first lamp groups having at least two lamps for a first region and the second lamp group having at least two lamps for the second region.

32. The method according to claim 31, wherein the second frame frequency is at least twice the first frame frequency.

33. A method of driving a liquid crystal display device with a liquid crystal panel having gate lines and data lines crossing each other, comprising:
driving the gate lines and data lines in accordance with a video data having a first frame frequency; and
controlling the first and second lamp groups to turn-on and turn-off simultaneously at a second frame frequency higher than the first frame frequency, the first lamp group having at least two lamps for a first region of the liquid crystal panel and the second lamp group having at least two lamps for a second region of the liquid crystal panel.

34. The method according to claim 33, wherein the second frame frequency is at least twice the first frame frequency.

35. The method according to claim 35, wherein the gate lines include:
first gate lines crossing the data lines on a third region occupying parts of the first and second regions; and
second gate lines crossing the data lines on a fourth region occupying remaining parts of the first and second regions.

36. A method for controlling a liquid crystal display device having a liquid crystal panel with first data lines crossing gate lines on a first region and second data lines crossing the gate lines on a second region, at least two first lamps partially corresponding to the first region of the liquid crystal panel, and at least two second lamps partially corresponding to the second region of the liquid crystal panel, the method comprising:
driving the gate lines and data lines to simultaneously write data voltages of a video data to liquid crystal cells of the first region and liquid crystal cells of the second region in line by line fashion; and
turning on and off once the first lamps together with the second lamps by one pair at a time.

37. The method according to claim 36, wherein the gate lines on the first region and the gate lines on the second region are sequentially enabled in synchronization with each other in each two period of a horizontal sync signal.

38. A method for controlling a liquid crystal display device having a liquid crystal panel with first data lines crossing gate lines on a first region and second data lines crossing the gate lines on a second region, at least two first lamps partially corresponding to the first region of the liquid crystal panel, and at least two second lamps partially corresponding to the second region of the liquid crystal panel, the method comprising:
driving the gate lines and data lines to simultaneously write data voltages of a video data to liquid crystal cells of the first region and liquid crystal cells of the second region in a line by line manner; and
driving the first and second lamps so that the lamps of the first and second lamps are turned on and off at time when an alignment saturation period elapses after the data voltages are written to liquid crystal cells on the liquid crystal panel.

39. The method according to claim 38, wherein the driving of the gate lines and the data lines includes enabling sequentially the gate lines on the first region and the gate lines on the second region in synchronization with each other in each period of a horizontal sync signal, and the driving of the lamps includes turning on and off the first and second lamps once in each frame.

40. The method according to claim 39, wherein the gate lines on the first region and the gate lines on the second region are sequentially enabled once in synchronization with each other during half frame period in each frame.
